(19) United States
(12) Patent Application Publication
(10) Pub. No.: US 2025/0176056 A1
(43) Pub. Date: May 29, 2025

(54) Configuration and Reporting for Deterministic Networks

(71) Applicant: Ofinno, LLC, Reston, VA (US)

(72) Inventors: Peyman Talebi Fard, Vienna, VA (US); Jian Xu, McLean, VA (US); Esmael Hejazi Dinan, McLean, VA (US); Kyungmin Park, Vienna, VA (US); Stanislav Filin, Chantilly, VA (US); SungDuck Chun, Fairfax, VA (US); Weihua Qiao, Herndon, VA (US)

(73) Assignee: Ofinno, LLC, Reston, VA (US)

(21) Appl. No.: 19/037,911

(22) Filed: Jan. 27, 2025

Related U.S. Application Data
(63) Continuation of application No. PCT/US2023/028863, filed on Jul. 27, 2023.
(60) Provisional application No. 63/393,664, filed on Jul. 29, 2022.

(51) Int. Cl. H04W 76/20; H04W 8/22; H04W 24/02

(52) U.S. Cl. CPC H04W 76/20; H04W 8/22; H04W 24/02

(57) ABSTRACT

A wireless device receives, from an access and mobility management function (AMF) in a first non-access stratum (NAS) message, parameters comprising a reporting configuration for a deterministic network (DetNet) node. The wireless device sends, to the AMF and based on the parameters, a second NAS message comprising a report for the DetNet node.

### CROSS-REFERENCE TO RELATED APPLICATIONS

This application is a continuation of International Application No. PCT/US2023/028863, filed Jul. 27, 2023, which claims the benefit of U.S. Provisional Application No. 63/393,664, filed Jul. 29, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates an example embodiment of a present disclosure.

FIG. 16 illustrates an example embodiment of a present disclosure.

FIG. 17 illustrates an example embodiment of a present disclosure.

FIG. 18 illustrates an example embodiment of a present disclosure.

FIG. 19 illustrates an example embodiment of a present disclosure.

FIG. 20 illustrates an example embodiment of a present disclosure.

FIG. 21 illustrates an example embodiment of a present disclosure.

FIG. 22 illustrates an example embodiment of a present disclosure.

FIG. 23 illustrates an example embodiment of a present disclosure.

FIG. 24 illustrates an example embodiment of a present disclosure.

FIG. 25 illustrates an example embodiment of a present disclosure.

FIG. 26 illustrates an example embodiment of a present disclosure.

FIG. 27 illustrates an example embodiment of a present disclosure.

FIG. 28 illustrates an example embodiment of a present disclosure.

FIG. 29 illustrates an example embodiment of a present disclosure.

FIG. 30 illustrates an example embodiment of a present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

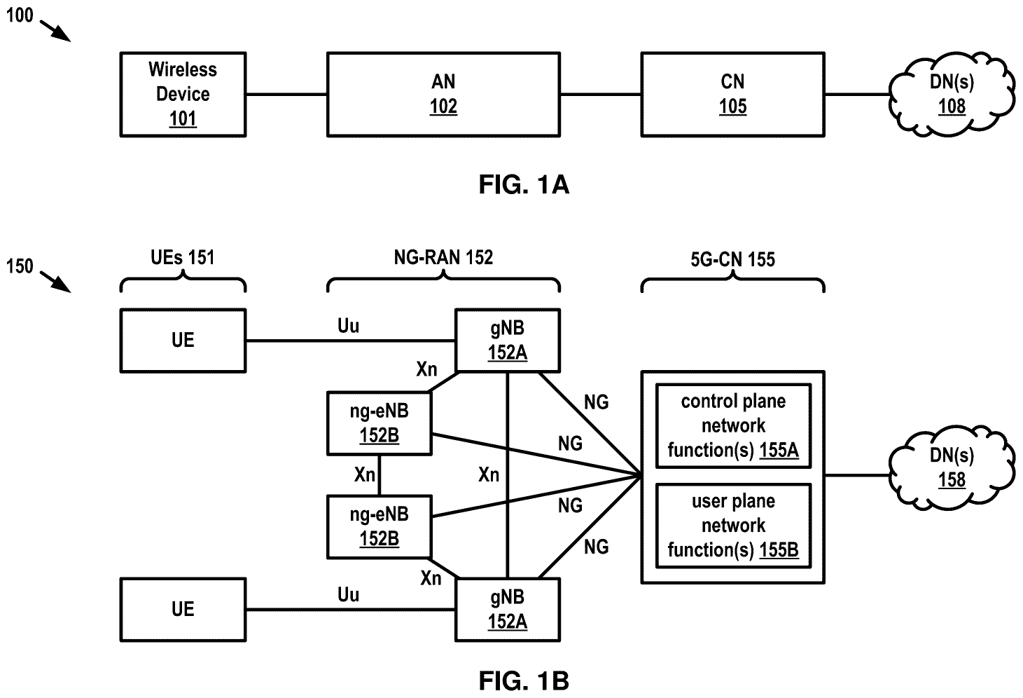

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

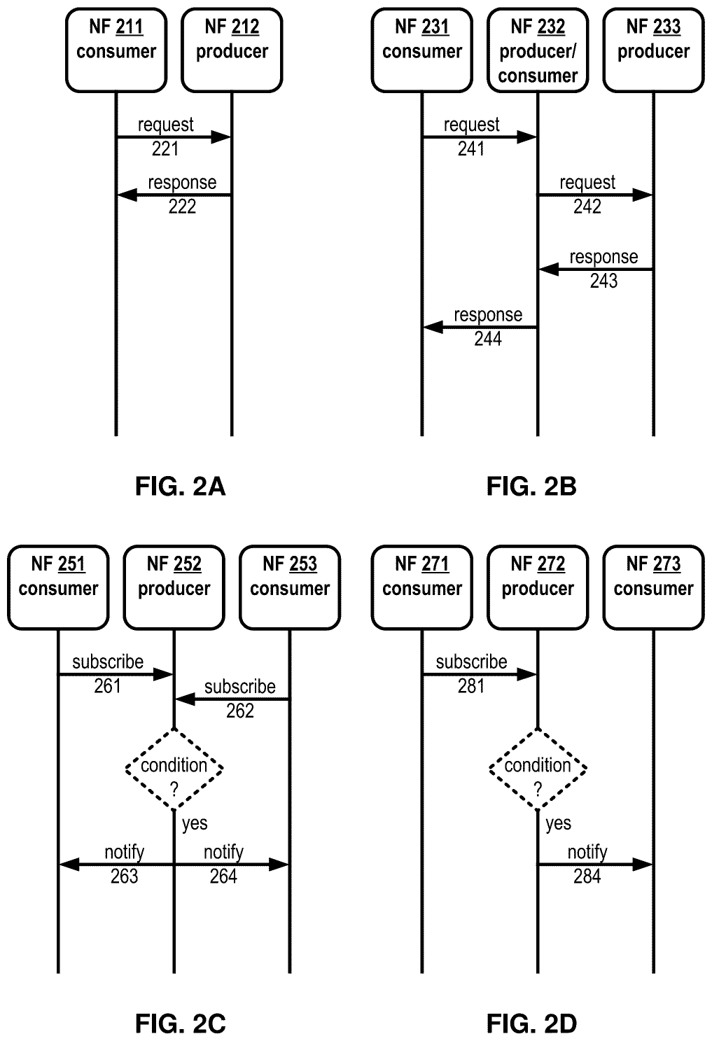

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

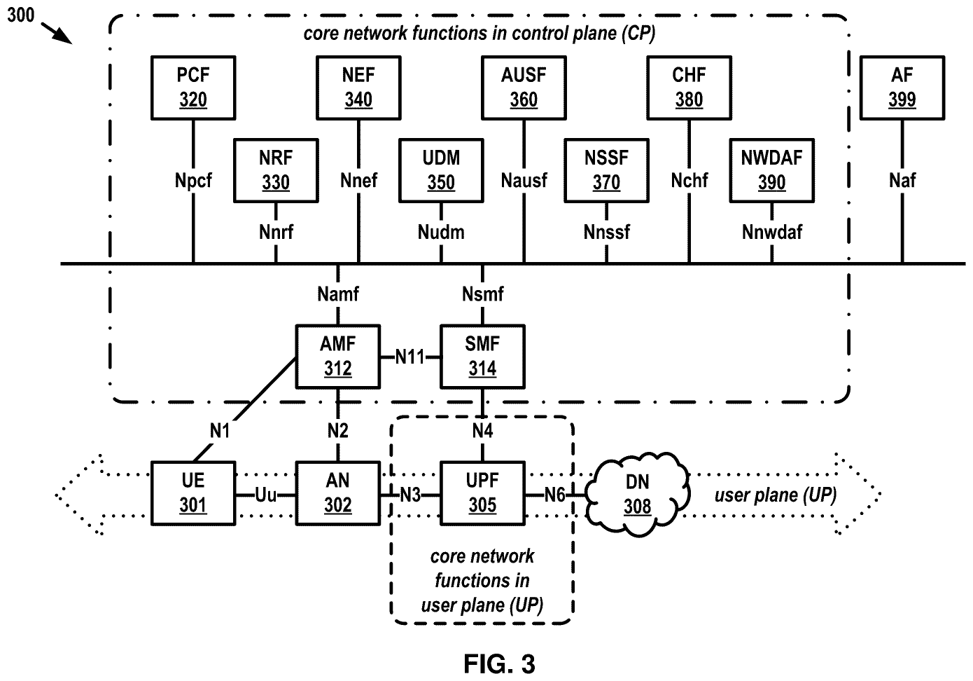

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QOS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PCF 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

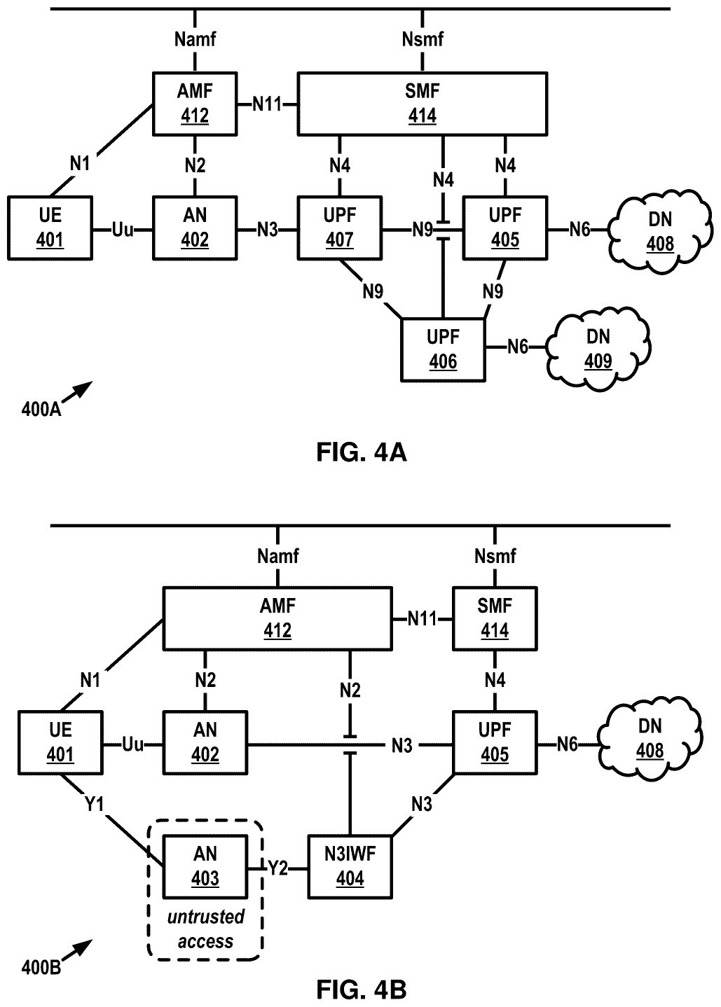

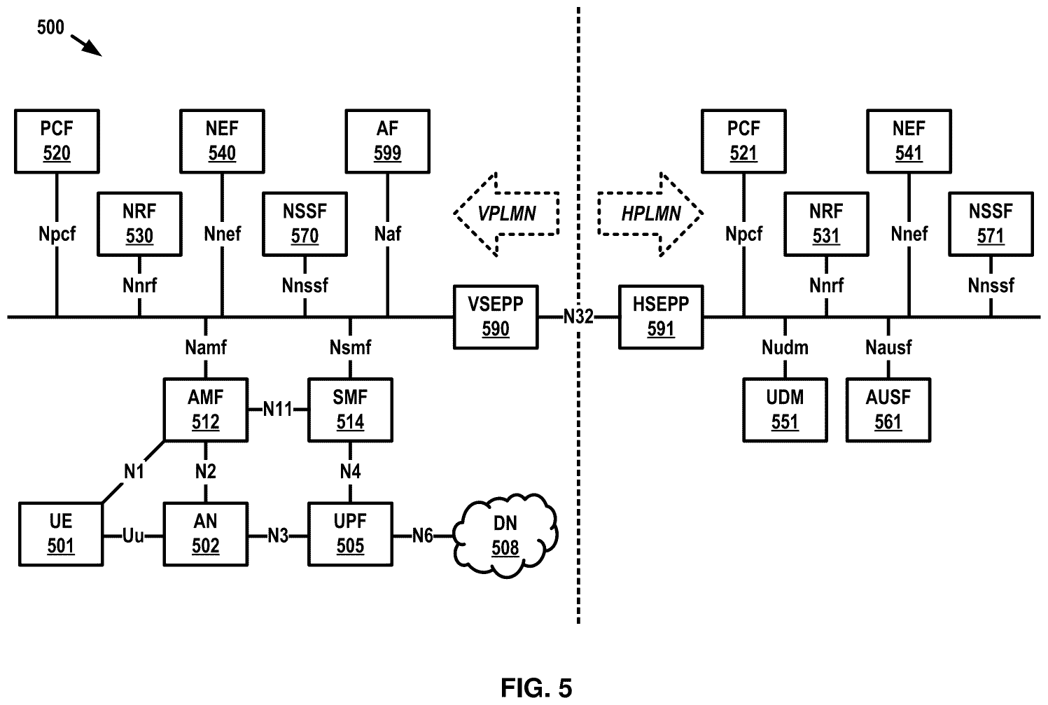

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

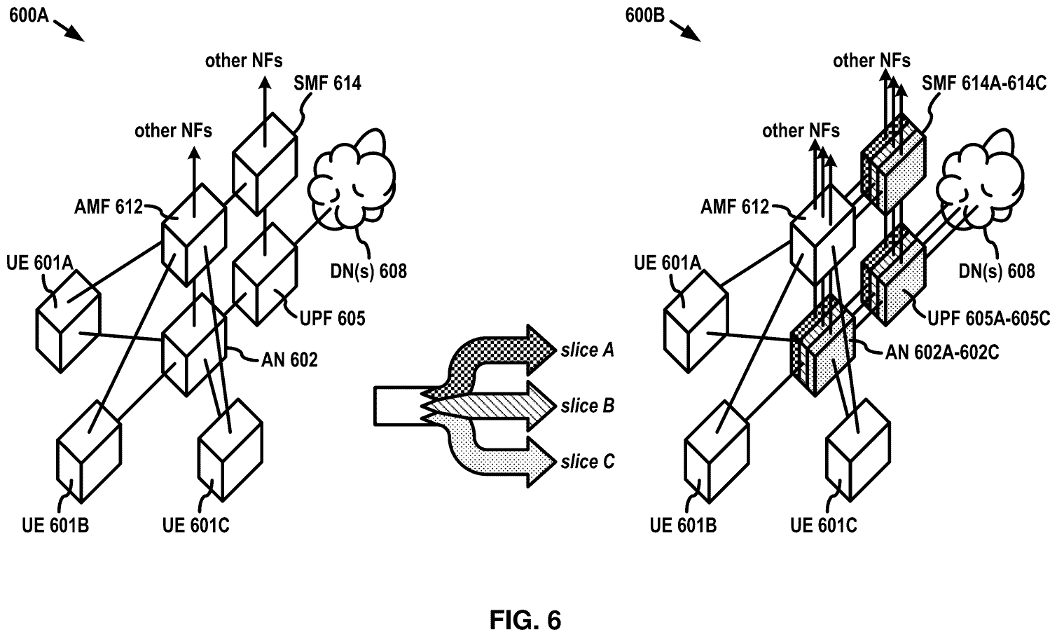

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

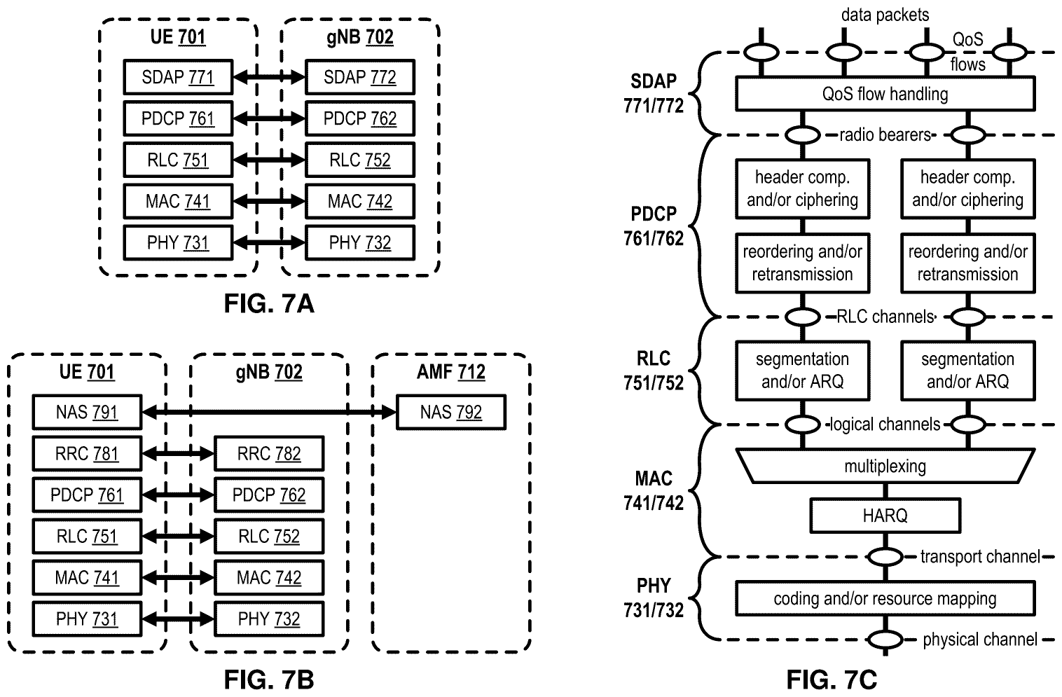

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QOS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

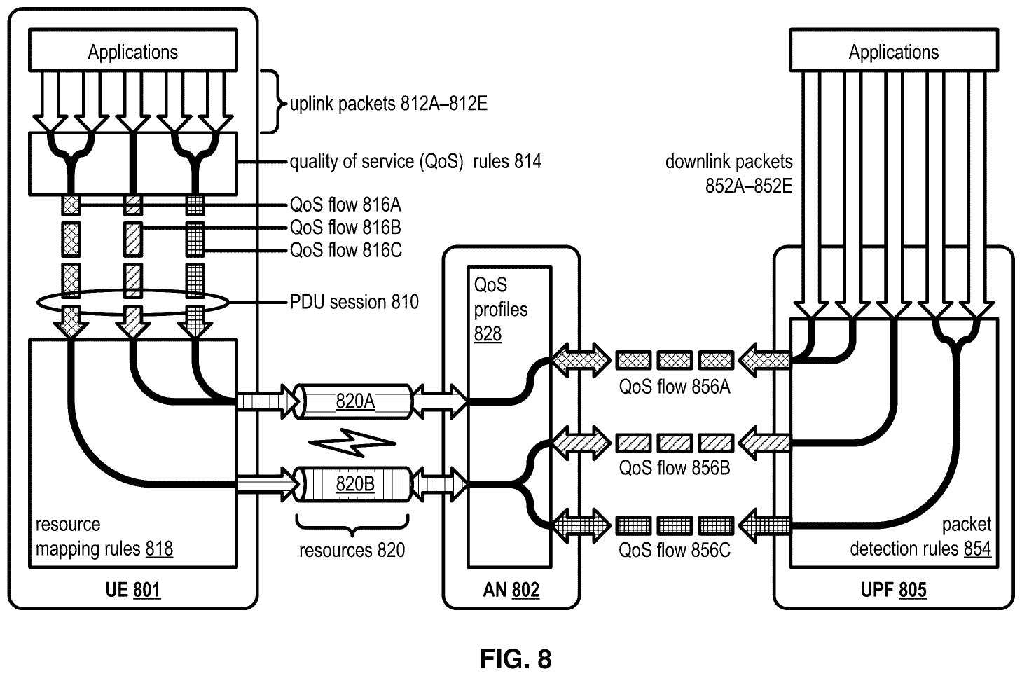

FIG. 8 illustrates an example of a quality of service (QOS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QOS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which have one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

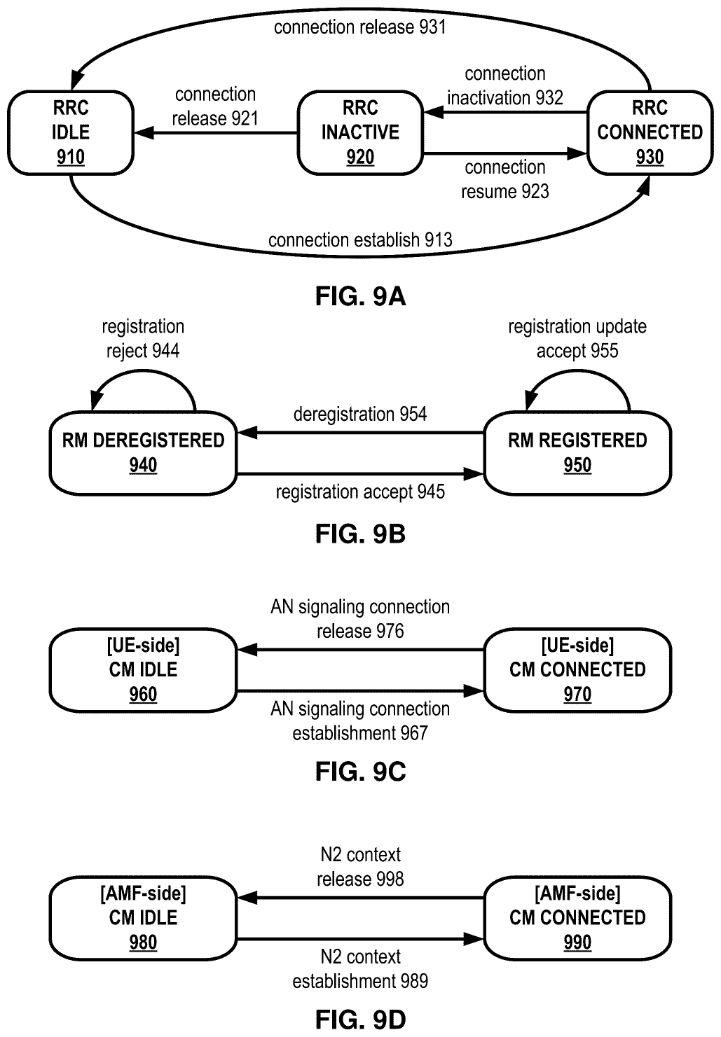

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

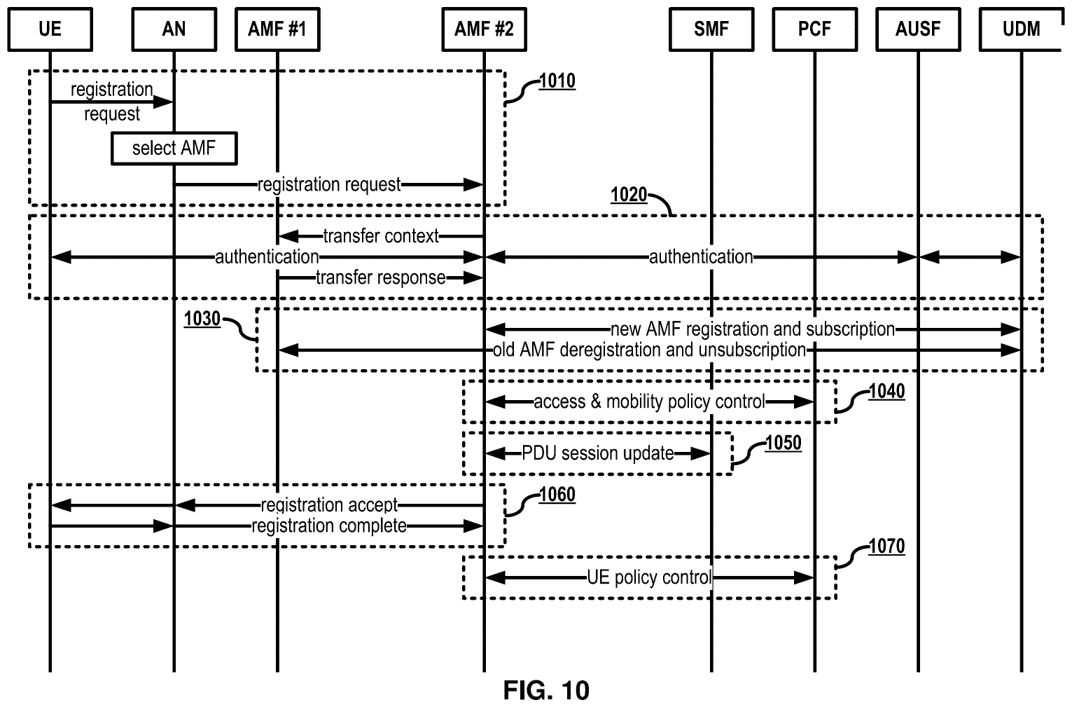

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

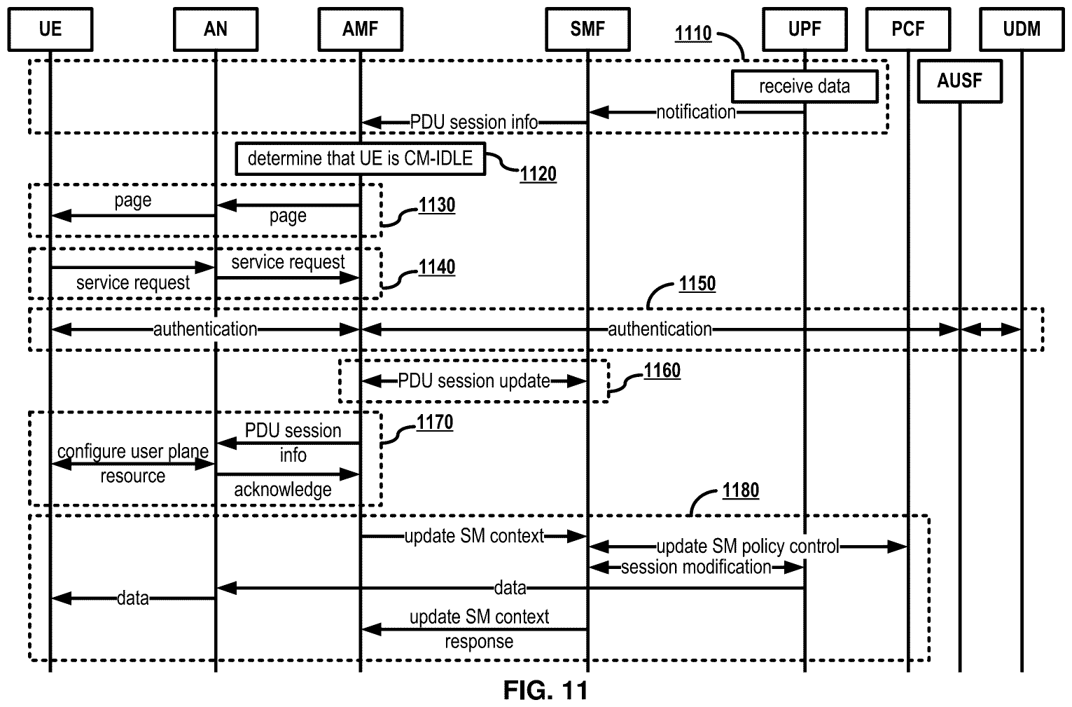

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

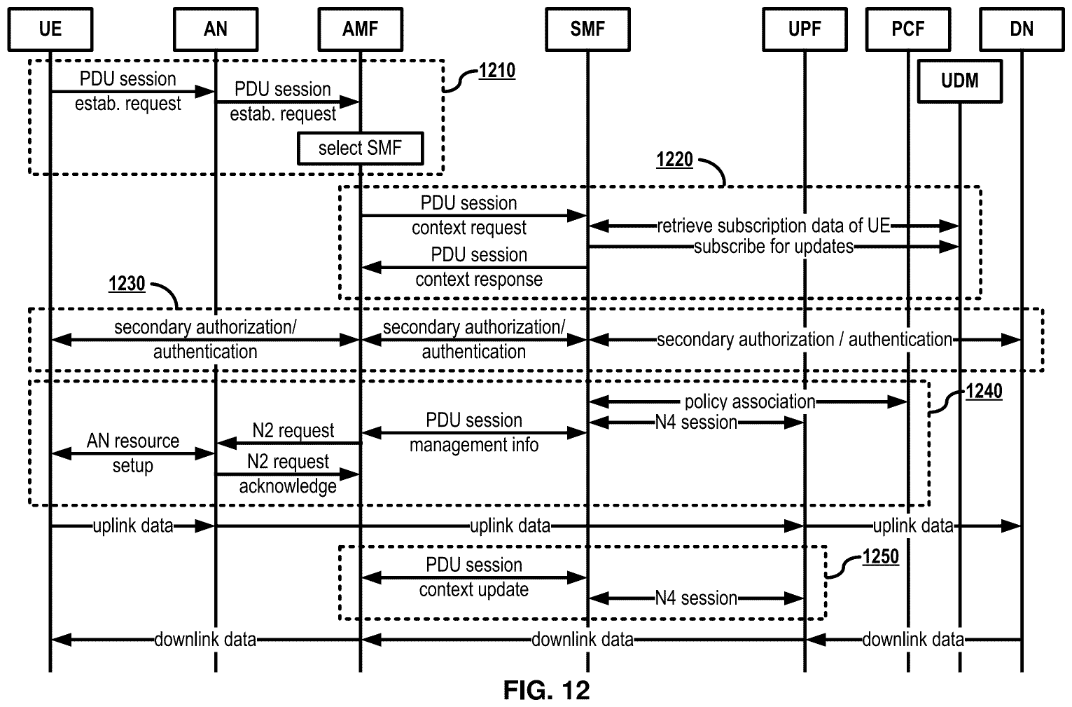

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QOS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

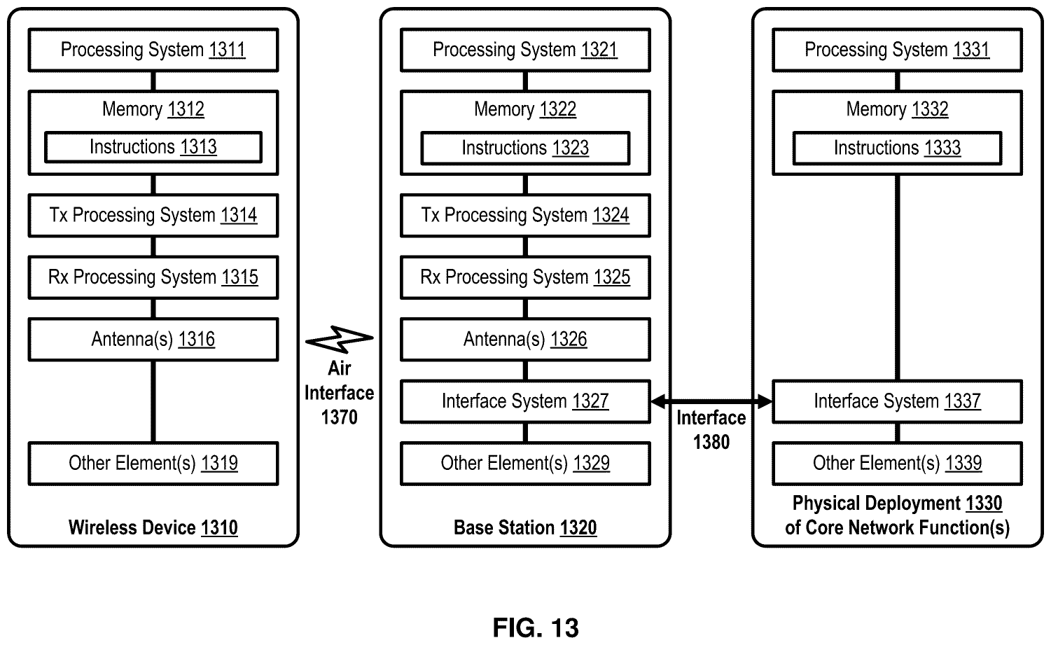

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICS, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a function al module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

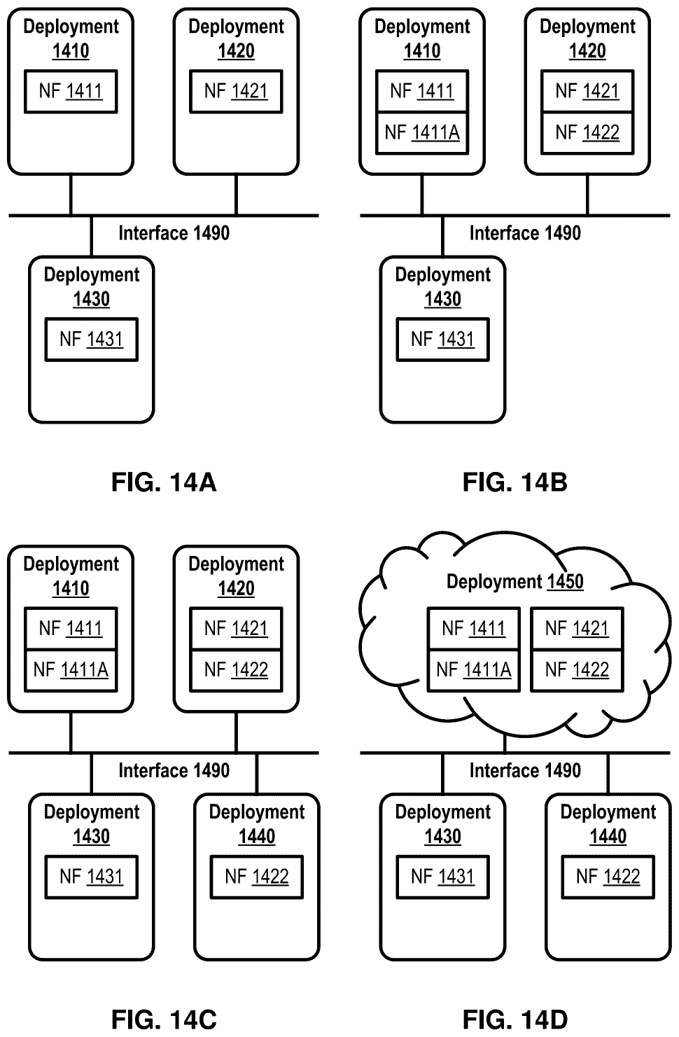

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

Deterministic Networking (DetNet) is an effort by the IETF DetNet Working Group to study implementation of deterministic data paths for real-time applications with extremely low data loss rates, packet delay variation (jitter), and bounded latency, such as audio and video streaming, industrial automation, and vehicle control. DetNet may operate at the IP Layer 3 routed segments using e.g., a Software-Defined Networking layer to provide IntServ and DiffServ integration, and may deliver service over lower Layer 2 bridged segments using technologies such as MPLS and IEEE 802.1 Time-Sensitive Networking (TSN). TSN is a set of IEEE standards to ensure low latency in Ethernet networks. The standard ensures that latency of a so-called “TSN stream” between two devices is always below a certain limit (e.g., 1 ms). Deterministic Networking aims to migrate time-critical, high-reliability industrial control and audio-video applications from special-purpose Fieldbus networks (such as HDMI, CAN bus, PROFIBUS, RS-485, RS-422/RS-232, and/or the like) to packet networks and the IP in particular. DetNet may support both the new applications and existing IT applications on the same physical network. To support real-time applications, DetNet may implement reservation of data plane resources in intermediate nodes along the data flow path, calculation of explicit routes that may or may not depend on network topology, and redistribute data packets over time and/or space to deliver data even with the loss of a path.

In an example, the 3GPP network may act as a TSN bridge e.g., layer 2 switching and/or bridging. In an example, the 3GPP system may be deployed to act as a DetNet node. A DetNet node may operate at layer 3. DetNet provides a capability for the delivery of data flows with extremely low packet loss rates and bounded end-to-end delivery latency. DetNet may be for networks that are under a single administrative control or within a closed group of administrative control; that may comprise campus-wide networks and private WANs.

In an example embodiment, time sensitive communication (TSC) Assistance Information (TSCAI) may be defined in the following table:

| Assistance Information | Description |
|---|---|
| Flow Direction | The direction of the TSC flow (uplink or downlink). |
| Periodicity | It refers to the time period between start of two data bursts. |
| Burst Arrival Time (optional) | The latest possible time when the first packet of the data burst arrives at either |
| | the ingress of the RAN (downlink flow direction) or the egress interface of the |
| | UE (uplink flow direction). |
| Survival Time (optional) | Survival Time, as defined in TS 22.261 [2], refers to the time period an |
| | application can survive without any data burst. |

TSCAI may be used by the 5G-AN, if provided by SMF. The knowledge of TSC traffic pattern is useful for 5G-AN as it allows more efficiently scheduling of QoS Flows that have a periodic, deterministic traffic characteristics either via Configured Grants, Semi-Persistent Scheduling or with Dynamic Grants.

The TSCTSF determines the TSC Assistance Container based on information provided by an AF/NEF and provides it to the PCF for IP type and Ethernet type PDU Sessions. In the case of integration with IEEE TSN network, the TSN AF determines TSC Assistance Container and provides it to the PCF for Ethernet PDU Sessions. The PCF receives the TSC Assistance Container from the TSCTSF or the TSN AF and forwards it to the SMF as part of PCC rule.

The SMF binds a PCC rule with a TSC Assistance Container to a QoS Flow. The SMF uses the TSC Assistance Container to derive the TSCAI for that QoS Flow and sends the derived TSCAI to the NG-RAN. The Periodicity, Burst Arrival Time, and Survival Time components of the TSCAI are specified by the SMF with respect to the 5G clock. The SMF is responsible for mapping the Burst Arrival Time and Periodicity from an external clock (when available) to the 5G clock based on the time offset and cumulative rateRatio (when available) between the external clock time and 5GS time as measured and reported by the UPF. The SMF determines the TSCAI.

A Survival Time, which indicates the time period an application can survive without any data burst, may be provided by TSN AF/AF either in terms of maximum number of messages (message is equivalent to all packets of a data burst) or in terms of time units. Only a single data burst is expected within a single time period referred to as the periodicity.

In an example a TSC assistance container may comprise:

| Assistance Information | Description |
|---|---|
| Flow Direction | The direction of the TSC flow (uplink or downlink). |
| Periodicity | It refers to the time period between start of two data bursts. |
| Burst Arrival Time (optional) | The time when the first packet of the data burst arrives at the ingress port of |
| | 5GS for a given flow direction (DS-TT for uplink, NW-TT for downlink). |
| Survival Time (optional) | It refers to the time period an application can survive without any data burst, as |
| | defined in TS 22.261 [2].. |
| Time Domain (optional) | The (g)PTP domain of the TSC flow. |

The DetNet QoS may be expressed in terms of one or more of the following:
Minimum and maximum end-to-end latency from source to destination, timely delivery, and bounded jitter (packet delay variation) derived from these constraints.
Packet loss ratio under various assumptions as to the operational states of the nodes and links.
An upper bound on out-of-order packet delivery. Some DetNet applications are unable to tolerate any out-of-order delivery.

It is a distinction of DetNet that it is concerned solely with worst-case values for the end-to-end latency, jitter, and misordering. Average, mean, or typical values are of little interest, because they do not affect the ability of a real-time system to perform its tasks. In general, a trivial priority-based queuing scheme may give better average latency to a data flow than DetNet; however, it may not be a suitable option for DetNet because of its worst-case latency.

Three techniques may be employed by DetNet to provide these qualities of service: Resource allocation, Service protection, and Explicit routes.

In an example, resource allocation may operate by assigning resources, e.g., buffer space or link bandwidth, to a DetNet flow (or flow aggregate) along its path. Resource allocation greatly reduces, or even eliminates entirely, packet loss due to output packet contention within the network, but it can only be supplied to a DetNet flow that is limited at the source to a maximum packet size and transmission rate. As DetNet flows are assumed to be rate limited and DetNet is designed to provide sufficient allocated resources (including provisioned capacity), the use of transport-layer congestion control for App-flows is not required; however, if resources are allocated appropriately, use of congestion control may not impact transmission negatively.

In an example, resource allocation may address two of the DetNet QoS requirements: latency and packet loss. Given that DetNet nodes have a finite amount of buffer space, resource allocation may result in a maximum end-to-end latency. Resource allocation also addresses contention-related packet loss. Other important contributions to packet loss may be random media errors and equipment failures. Service protection is the name for the mechanisms used by DetNet to address these losses. The mechanisms employed are constrained by the need to meet the users' latency requirements. Packet replication and elimination and packet encoding may provide service protection, but other mechanisms may also be found. For instance, packet encoding can be used to provide service protection against random media errors, while packet replication and elimination can be used to provide service protection against equipment failures. This mechanism distributes the contents of DetNet flows over multiple paths in time and/or space, so that the loss of some of the paths does need not cause the loss of any packets.

Standard IT infrastructure may not efficiently handle latency-sensitive data. Switches and routers use fundamentally uncertain algorithms for processing packet/frames, which may result in sporadic data flow. A solution for smoothing out these flows is to properly configure DetNet nodes, DetNet resources, and/or the like. DetNet may employ deterministic algorithms for queuing, shaping and scheduling which allow each node to allocate bandwidth and latency according to requirements of each data flow, by computing the buffer size at a DetNet node.

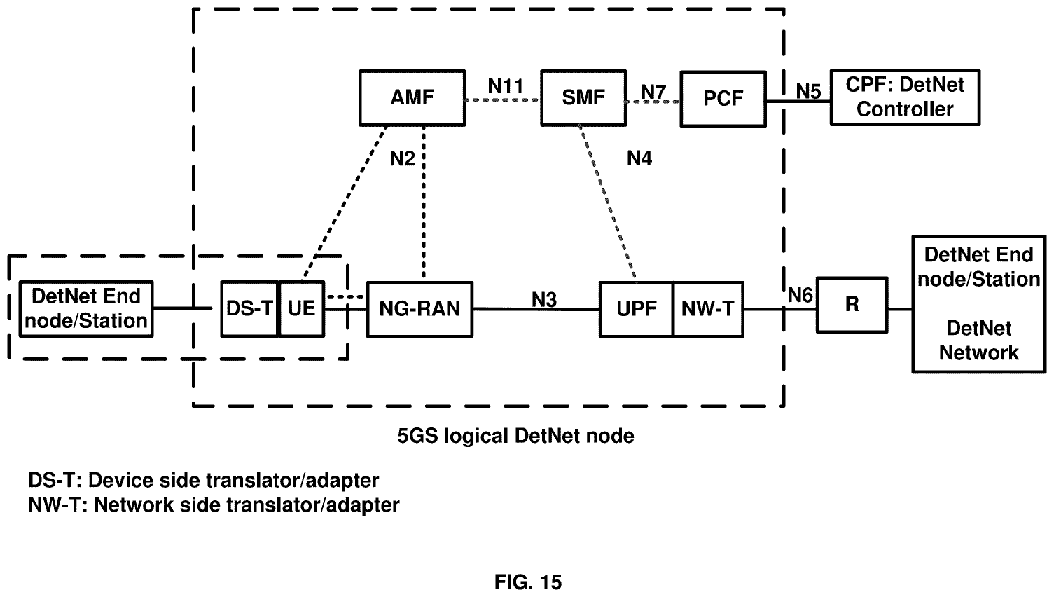

FIG. 15 illustrates a 3GPP system/network configured to act as a DetNet node. As depicted in example FIG. 15, a 3GPP or 5G system (5GS) may be a logical DetNet node. A UE may be configured to act as a device side of the DetNet node. The UE may be connected to or be integrated with a translator device/module (DS-T). In an example, the translator device may be a DetNet Translator device such as device side DetNet translator (DS-DT). A UPF may be configured to act as a network side of the DetNet node. The UPF may be connected to or be integrated with a translator device/module (NW-T). In an example, the translator device may be a DetNet Translator device such as network side DetNet translator (NW-DT).

In an example, the UPF node may have routing functionality on the N6 interface side which is implementation specific. In deployments where the implementation specific routing functionality on the N6 side also needs to be configured for DetNet, direct configuration may be used between the control plane function (CPF) (e.g., the DetNet controller) and the routing functionality co-located with the UPF. This case can be modelled with a single interface between the UPF and the router (R as shown in FIG. 15). In an example, when the UPF and the router are co-located in the same physical node, then the interface between them may be modeled as a single virtual interface.

The DetNet node or DetNet system may comprise a DetNet controller entity that may act as a DetNet Control Plane, a control plane function (CPF), and/or the like. The DetNet control plane may support the dynamic creation, modification, and deletion of DetNet flows. This may include some or all of explicit path determination, link bandwidth reservations, restricting flows to specific links (e.g., IEEE 802.1 Time-Sensitive Networking (TSN) links), node buffer and other resource reservations, specification of required queuing disciplines along the path, ability to manage bidirectional flows, and/or the like, as needed for a (DetNet) flow.

The DetNet control plane may support DetNet flow aggregation and de-aggregation via the ability to dynamically create and delete flow aggregates (FAs), and be able to modify existing FAs by adding or deleting participating flows. The DetNet control plane may allow flow instantiation requests to originate in an end application (via an Application Programming Interface (API), via static provisioning, or via a dynamic control plane, such as a centralized SDN controller or distributed signaling protocols. The DetNet control plane may support queue control techniques.

The DetNet control plane may support advertising static and dynamic node and link resources such as capabilities and adjacencies to other network nodes (for dynamic signaling approaches) or to network controllers (for centralized approaches). The DetNet control plane may support scaling to handle the number of DetNet flows expected in a domain (which may require per-flow signaling or provisioning). The DetNet control plane may support provision flow identification information at each of the nodes along the path. Flow identification may differ depending on the location in the network and the DetNet functionality (e.g. transit node vs. relay node).

The DetNet control plane may support monitoring the performance of DetNet flows and nodes to ensure that they are meeting required objectives, both proactively and on-demand. The DetNet control plane may support DetNet flow continuity check and connectivity verification functions. The DetNet control plane may support testing and monitoring of packet replication, duplicate elimination, and packet ordering functionality in the DetNet domain.

The DetNet control plane may support adaptation to DetNet domain topology changes such as links or nodes failures (fault recovery/restoration), additions and removals.

In an example, a DetNet flow may be a sequence of packets that conforms uniquely to a flow identifier and to which the DetNet service is to be provided. It may comprise any DetNet headers added to support the DetNet service and forwarding sub-layers.

In an example, a DetNet service may comprise a DetNet service sub-layer. In an example, DetNet functionality may be divided into two sub-layers. One of them is the DetNet service sub-layer, at which a DetNet service (e.g., service protection) is provided. DetNet service proxy may be a proxy that maps between App-flows and DetNet flows.

In an example, mapping relationship between DetNet flow and 5GS parameters may be employed as follows:
The DetNet flow identifier may be the unique identification. It can be mapped to QFI under 5GS QoS framework.
The DetNet IP flow description may describes the characteristics of service; it can be mapped to Packet filter Set under 5GS QoS framework.

The traffic specification requirements of DetNet flow are specific service requirements for specific flows. It can be mapped to QoS profile under 5GS QoS framework. The specific mapping methods may be as follows:
The minimum guaranteed bandwidth is mapped to GFBR in QoS profile;
The maximum delay is mapped to 5QI-PDB in QoS profile;
Expand the parameters of 5QI in QoS profile, the maximum delay variation range is mapped to 5QI-PDB Deterministic;
The maximum packet loss is mapped to 5QI-Error Rate in QoS profile;
Expand the parameters of 5QI in QoS profile, the maximum continuous packet loss is mapped to 5QI-Max Continuous Error;

Expand the parameters of 5QI in QoS profile, the maximum disorder that can be tolerated is mapped to 5QI-Misordering.

In an example, some service protection mechanisms may rely on switching from one flow to another when a failure of a flow is detected.

In an example, packet replication and elimination combines the DetNet member flows sent along multiple different paths and performs a packet-by-packet selection of which to discard, e.g., based on sequencing information.

In an example embodiment, failure may occur due to signaling, user plane failure, media failure, equipment fault/failure, path failure, and/or the like. In an example embodiment, if a DetNet flow passes through one or more DetNet-unaware network nodes between two DetNet nodes providing the DetNet forwarding sub-layer for that flow, there is a potential for disruption or failure of the DetNet QoS. In an example embodiment, failure may occur at an ingress or egress interface of a DetNet node or DetNet system. The egress and/or the ingress may be located at the network side such as the UPF. In an example, the egress/ingress may be located at the device side of the DetNet node. In an example, a failure may be defined by a failure code indicating the cause or location of a failure.

In an example, the failure may be related to DetNet flow. In an example, the failure code (FailureCode) may be a non-zero code that specifies the error if the DetNet flow encounters a failure (e.g., packet replication and elimination is requested but not possible, or DnIngressStatus is Failed, or DnEgressStatus is Failed, or DnEgressStatus is PartialFailed).

In an example, the failure may be related to DetNet service failure that may be reported by a code such as DetNet service failure code (DnServiceFailureCode). The DetNet service failure code may be a non-zero code that specifies the error if the DetNet service encounters a failure (e.g., packet replication and elimination is requested but not possible, or DnServiceIngressStatus is Failed, or DnServiceEgressStatus is Failed, or DnServiceEgressStatus is PartialFailed).

In an example, failures may cause degradation of QoS and service for the DetNet, may cause packet loss, link failures, and/or the like.

In an example, a DetNet parameter may comprise at least one of a 1) DetNet flow parameter (DetNet flow information element IE, DetNet flow IE) that may comprise characteristics of data flows; 2) DetNet service parameter (DetNet service IE) that may comprise characteristics of services being provided for data flows over a network; 3) DetNet configuration parameter (DetNet configuration IE) that may comprise in detail the settings and parameters required on network nodes to provide a data flow proper service.

In an example, a DetNet flow assistance information container may comprise at least one or more elements of the DetNet parameter.

In an example, the DetNet flow IE and the DetNet service IE may comprise three groups of information elements: App-flow related parameters (these describe the App-flow characteristics (e.g., identification, encapsulation, traffic specification, endpoints, status, etc.) and the App-flow service expectations (e.g., delay, loss, etc.)), DetNet flow related parameters (these describe the DetNet flow characteristics (e.g., identification, format, traffic specification, endpoints, rank, etc.)), DetNet service related parameters: these describe the expected service characteristics (e.g., delivery type, connectivity delay/loss, status, rank, etc.).

In an example, App-flow characteristics may comprise:
FlowID: a unique (management) identifier of the App-flow. It can be used to define the N:1 mapping of App-flows to a DetNet flow.
Flow Type: set by the encapsulation format of the flow. It may be Ethernet (TSN), MPLS, or IP.
DataFlowSpecification: a flow descriptor, defining which packets belongs to a flow using, specific packet header fields such as src-addr, dst-addr, label, VLAN-ID, and/or the like.
TrafficSpecification: a flow descriptor, defining traffic parameters such as packet size, transmission time interval, and maximum packets per time interval.
FlowEndpoints: delineate the start and termination reference points of the App-flow by pointing to the source interface/node and destination interface(s)/node(s).
FlowStatus: indicates the status of the App-flow with respect to the establishment of the flow by the connected network, e.g., ready, failed, etc.
FlowRank: indicates the rank of this flow relative to other flows in the connected network.

In an example, the DetNet parameter may comprise the App-flow characteristics.

In an example, App-flow requirements may comprise:
FlowRequirements: defines the attributes of the App-flow regarding bandwidth, latency, latency variation, loss, and misordering tolerance.
FlowBiDir: defines the data path requirement of the App-flow whether it must share the same data path and physical path for both directions through the network, e.g., to provide congruent paths in the two directions.

In an example, the DetNet flow IE may comprise: DetNet flow identifier ID DnFlowID (A unique (management) identifier is needed for each DetNet flow within the DetNet domain. It is specified by DnFlowID. It can be used to define the many to one mapping of DetNet flows to a DetNet service), DnPayloadType (The DnPayloadType attribute may be set according to the encapsulated App-flow format. The attribute can be Ethernet, MPLS, or IP), DnFlowFormat, DnFlowSpecification, DnTrafficSpecification, DnFlowEndpoints, DnFlowRank, DnFlowStatus, DnFlowRequirements, DnFlowBiDir, and/or the like.

In an example, the DetNet flow ID may protocol specific identifiers such as addresses, labels (e.g., for MPLS), and/or the like. For example, DetNet IP flows may be identified and specified by the following attributes: a. SourceIpAddress; b. DestinationIpAddress; c. IPv6FlowLabel; d. Dscp (attribute); e. Protocol; f. SourcePort; g. DestinationPort; h. IPSecSpi.

In an example, DetNet traffic specification may comprise the following attributes: a. Interval: the period of time in which the traffic specification is specified; b. MaxPacketsPerInterval: the maximum number of packets that the; Ingress will transmit in one Interval; c. MaxPayloadSize: the maximum payload size that the Ingress will transmit.

In an example, the DnFlowEndpoints attribute defines the starting and termination reference points of the DetNet flow by pointing to the ingress interface/node and egress interface(s)/node(s). Depending on the network scenario it defines an interface or a node. Interface can be defined for example if the App-flow is a TSN Stream and it is received over a well defined UNI interface. For example, for App-flows with MPLS encapsulation defining an ingress node is more common when per platform label space is used.

In an example, rank of the DetNet Flow, the DnFlowRank attribute may provides the rank of this flow relative to other flows in the DetNet domain. Rank (range: 0-255) is used by the DetNet domain to decide which flows can and cannot exist when network resources reach their limit. Rank is used to help to determine which flows can be bumped (i.e., removed from node configuration thereby releasing its resources) if for example a port of a node becomes oversubscribed (e.g., due to network re-configuration).

In an example, status of the DetNet Flow, DnFlowStatus may provide/comprise the status of the DetNet flow with respect to the establishment of the flow by the DetNet domain.

The DnFlowStatus may comprise the following attributes:
a. DnIngressStatus is an enumeration for the status of the flow's Ingress reference point:
   None: no Ingress.
   Ready: Ingress is ready.
   Failed: Ingress failed.
   OutOfService: Administratively blocked.
b. DnEgressStatus is an enumeration for the status of the flow's Egress reference points:
   None: no Egress.
   Ready: all Egresses are ready.
   PartialFailed: One or more Egress ready, and one or more Egress failed. The DetNet flow can be used if the Ingress is Ready.
   Failed: All Egresses failed.
   OutOfService: Administratively blocked.
c. FailureCode: A non-zero code that specifies the error if the DetNet flow encounters a failure (e.g., packet replication and elimination is requested but not possible, or DnIngressStatus is Failed, or DnEgressStatus is Failed, or DnEgressStatus is PartialFailed).

In an example, requirements of the DetNet Flow, DnFlowRequirements may specify requirements to ensure the service level desired for the DetNet flow. The DnFlowRequirements may comprise the following attributes: a. MinBandwidth; b. MaxLatency; c. MaxLatency Variation; d. MaxLoss; e. MaxConsecutiveLossTolerance; f. MaxMisordering;

In an example, DetNet Service Related Parameters may comprise: a. DnServiceID; b. DnServiceDeliveryType; c. DnServiceDeliveryProfile; d. DNServiceConnectivity; e. DnServiceBiDir; f. DnServiceRank; g. DnServiceStatus.

In an example, status of the DetNet Service may comprise the following. DnServiceStatus information group includes elements that specify the status of the service specific state of the DetNet domain. This information group informs the user whether or not the service is ready for use. The DnServiceStatus may comprise the following attributes:
a. DnServiceIngressStatus is an enumeration for the status of the service's Ingress:
   None: no Ingress.
   Ready: Ingress is ready.
   Failed: Ingress failed.
   OutOfService: Administratively blocked.
b. DnServiceEgressStatus is an enumeration for the status of the service's Egress:
   None: no Egress.
   Ready: all Egresses are ready.
   PartialFailed: One or more Egress ready, and one or more Egress failed. The DetNet flow can be used if the Ingress is Ready.
   Failed: All Egresses failed.
   OutOfService: Administratively blocked.
c. DnServiceFailureCode: A non-zero code that specifies the error if the DetNet service encounters a failure (e.g., packet replication and elimination is requested but not possible, or DnServiceIngressStatus is Failed, or DnServiceEgressStatus is Failed, or DnServiceEgressStatus is PartialFailed).

A DetNet node may be implemented using a UPF node (configured with parameters for the network side translator device of the DetNet node) and a UE (configured to act as the device side translator device of the DetNet node). When a new DetNet node is configured (e.g., a network is configured to act as a DetNet node), the UE that is part of the DetNet node may receive traffic (data packets) for a DetNet flow. In an example, a DetNet flow may be assigned a designated path (e.g., DetNet nodes) by the DetNet controller. In existing technologies, when a UE receives a request from a DetNet end node or another DetNet node, for transmission of data packets of a DetNet flow, the UE may send data packets via a PDU session. The PDU session may not correspond with the UPF acting as the corresponding DetNet node. Furthermore, a DetNet node may be assigned a network slice and dedicated resources to meet the requirements of the DetNet flow. In existing technologies, the UE may transmit the DetNet flow via a PDU session that does not have sufficient resources and/or associated with network slices or resources that are not part of the DetNet.

In an example, a UE may be registered with a network that supports one or more DetNet nodes. In an example, the UE may be part of one of the one or more DetNet nodes. In an example, the UE may be allowed to route data packets associated with a DetNet flow of a specific DetNet node.

Example embodiments provide enhancement of signaling during registration of the UE, configuration update procedure, reporting procedure, and/or the like to provision parameters associated with elements of the DetNet system within the network.

In an example, DetNet may be employed a wide range of use cases such as professional audio and video (Audio Video Bridging), electrical generation and distribution; building automation systems (BAS); wireless industrial mesh networks; cellular radio (fronthaul/backhaul); industrial machine to machine (M2M) networks; mining industry (remote vehicle control); private blockchain; network slicing, and/or the like.

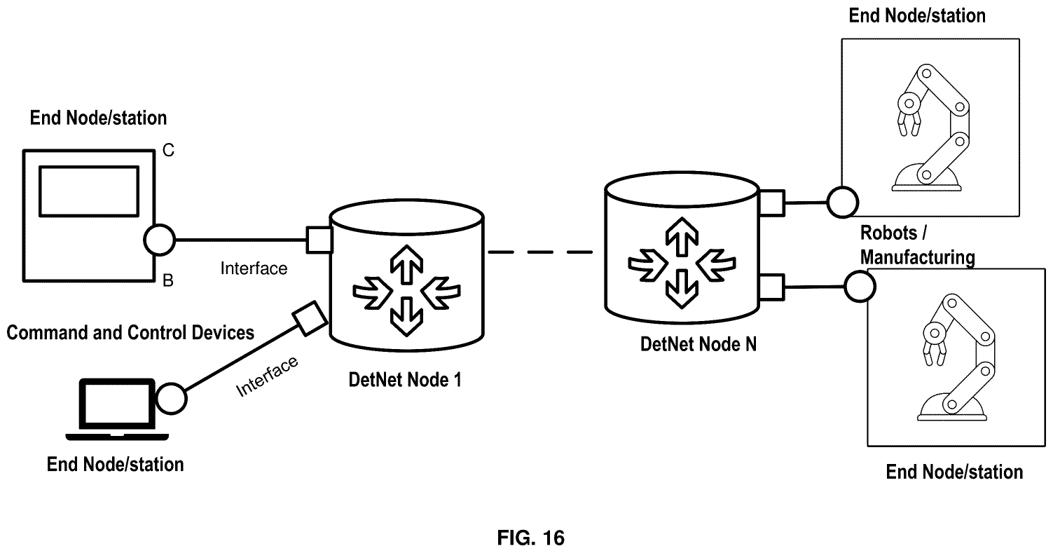

As depicted in FIG. 16, DetNet nodes that may operate as layer 3 routers may be employed in a factory. In an example, control devices may communicate with the robots via one or more DetNet nodes by establishment of DetNet flows from control device to a robot for transmission of commands and receiving information from the robots. In an example, various departments may be run over a different network. For example, the factory robots may be under a separate local network, and control devices may be under another local network administrator. In an example, DetNet routing may allow multiple networks to communicate independently and yet remain separate and isolated. In an example, when TSN bridging is employed, only a single network may be supported and in TSN bridge deployment, separate networks will be seen as one network and cannot be separated.

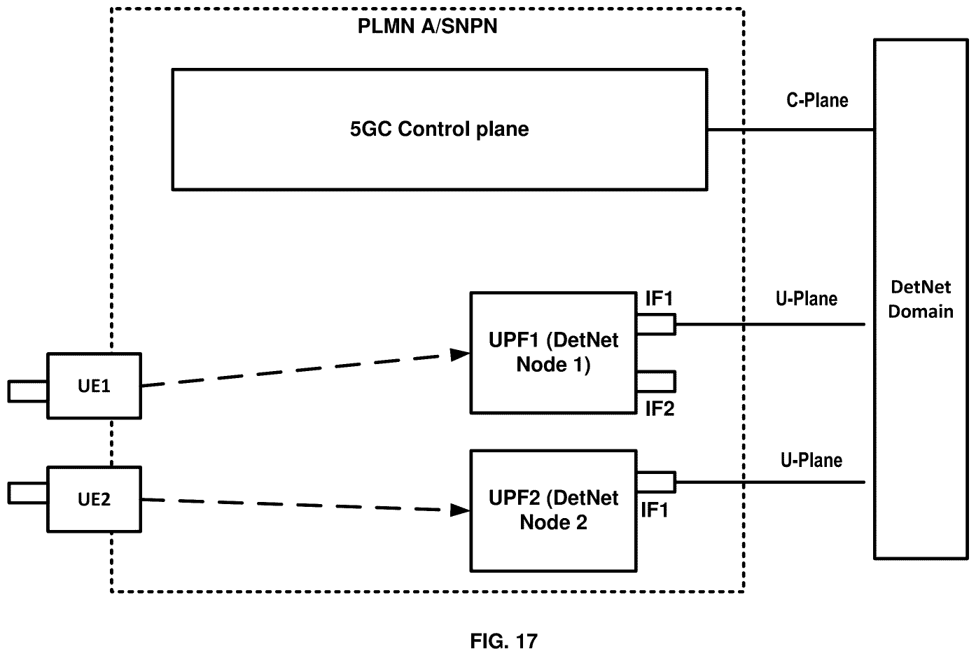

FIG. 17 depicts an example configuration/deployment of DetNet node. In an example, the network (e.g., the 3GPP network: RAN, core and user plane) may be configured with one or more UPFs that act as a DetNet node. In an example, the network may be deployed to act as one or more DetNet nodes. In the example of FIG. 17, the network comprises two DetNet nodes (DetNet node 1 and DetNet node 2) e.g., configured on UPF 1 and UPF 2. In an example UE 1 may act as the device side of DetNet node 1 and UE 2 may act as the device side of DetNet node 2.

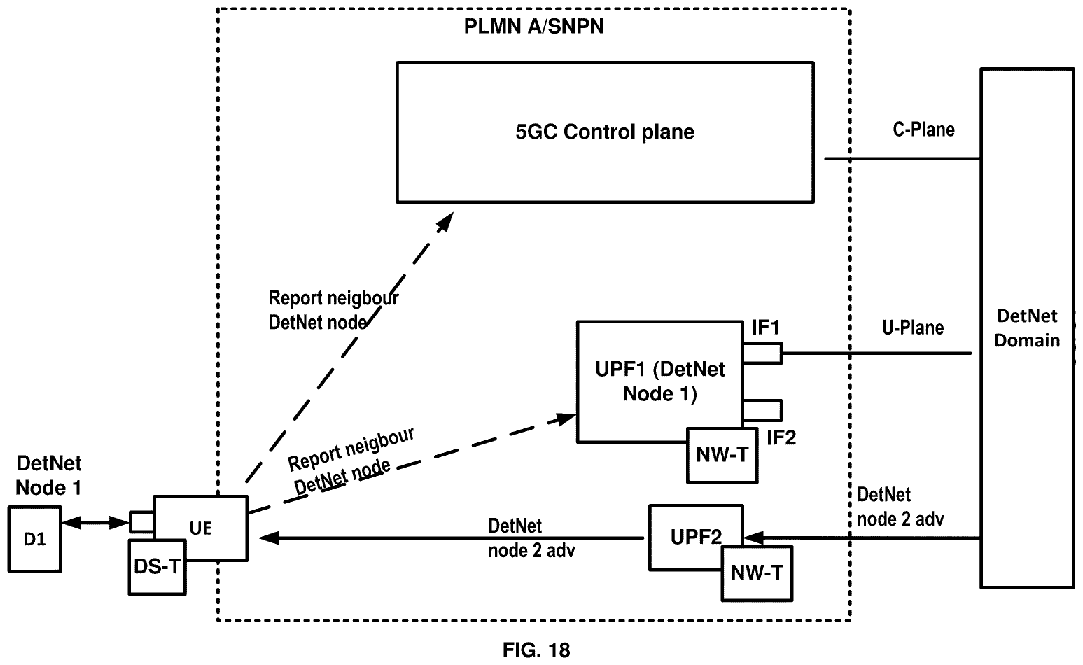

FIG. 18 depicts an example configuration/deployment of DetNet node. In an example, a DetNet node may perform a router/node advertisement for neighbor discovery procedures. In an example, the network (e.g., the 3GPP network: RAN, core and user plane) may be configured with one or more UPFs that act as a DetNet node. In an example, the network may be deployed to act as one or more DetNet nodes. In the example of FIG. 18, the network comprises two DetNet nodes (DetNet node 1 and DetNet node 2) e.g., configured on UPF 1 and UPF 2. In an example the UE may act as the device side of DetNet node 1 and DetNet node 2. In an example, upon configuration of a new DetNet node, the UPF or the UE may report to the network the discovery of the new DetNet node. In an example, the UE may receive a message from a UPF or a DetNet node comprising a DetNet node ID. In an example, the UE may send a NAS message to the network e.g., the SMF, the AMF and/or the like. In an example, the NAS message may comprise the DetNet node ID.

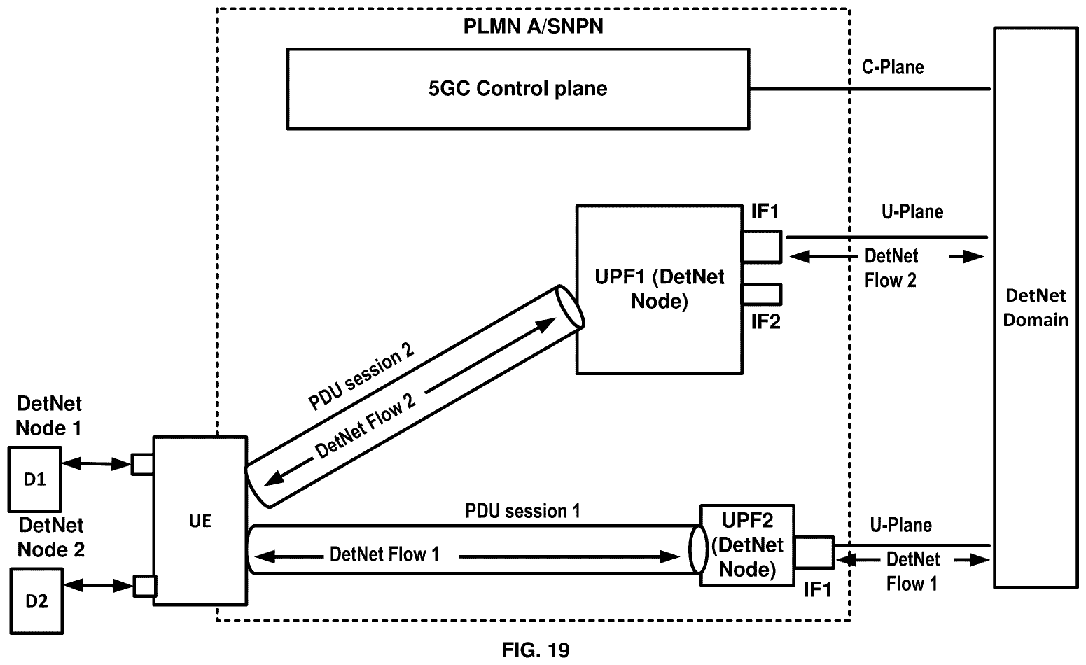

FIG. 19 depicts an example configuration/deployment of DetNet. In an example, a network may be deployed to act a one or more DetNet nodes (e.g., DetNet node 1 and DetNet 2). In an example, a PDU session of the UE may be dedicated to a DetNet flow. As shown in the example, PDU session 1 may be dedicated to DetNet flow 1, and PDU session 2 may be employed to transmit and receive data packets of DetNet flow 2.

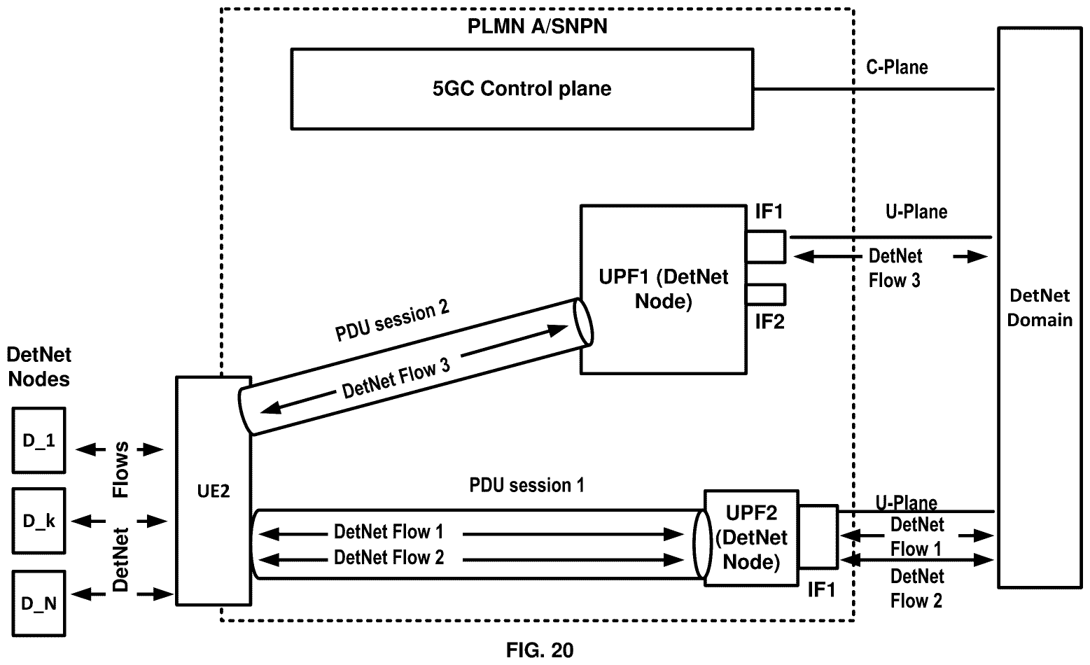

FIG. 20 illustrates an example of a network deployed as a DetNet node wherein the UE may employ a PDU session for transmission of one or more DetNet flows. As shown in the example, PDU session 1 may be shared between one or more DetNet flows, and PDU session 2 may be employed to transmit and receive data packets of DetNet flow 3. PDU session 1 may be employed to transmit and receive data packets of DetNet flow 1 and DetNet flow 2. The device side of the DetNet node may be connected to one or more DetNet nodes (D_1, . . . , D_k, . . . , D_N).

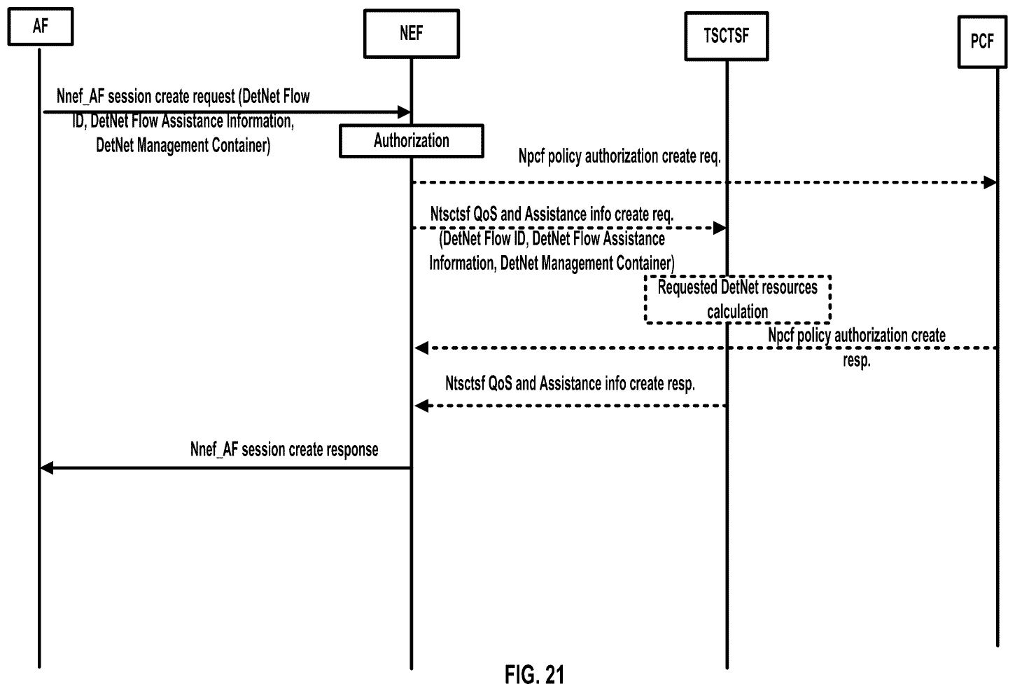

FIG. 21 illustrates an example AF (DetNet controller entity) initiated DetNet configuration, or DetNet flow creation procedure in a network in accordance with embodiments of the present disclosure. In an example, the AF (DetNet controller entity) may send a request to reserve resources for an AF session using Nnef_AFsessionWithQoS_Create request message. In an example, the message comprises a DetNet parameter, a DetNet flow id, a DetNet flow assistance information, a DetNet management container, a DetNet node ID, UE address, AF Identifier, Flow description(s) or External Application Identifier, QoS reference, (optional) Alternative Service. In an example, a period of time or a traffic volume for the requested QoS can be included in the AF request. The AF may, instead of a QoS Reference, provide the following individual QoS parameters: Requested 5GS delay (optional), Requested Priority (optional), Requested GFBR, Requested MFBR, flow direction, Burst Size (optional), Burst Arrival Time (optional) at UE (uplink) or UPF (downlink), Periodicity (optional), Time domain (optional), Survival Time (optional).

In an example embodiment, the DetNet parameter may comprise the DetNet service related parameters, requirements of the DetNet Flow, DnFlowRequirements, an identifier of a DetNet node, and/or the like.

In an example embodiment the DetNet flow id may comprise IP or MPLS related addresses, and/or labels (e.g., endpoint identifiers, or the like).

In an example embodiment, the DetNet flow assistance information may comprise the DetNet flow requirements e.g., DnFlowRequirements.

In an example embodiment, the DetNet management container may comprise DetNet resource information container, DetNet flow parameter, DetNet service parameter, DetNet configuration parameter, and/or the like.

In an example, the NEF may assign a Transaction Reference ID to the Nnef_AFsessionWithQoS_Create request. The NEF may authorizes the AF request and may apply policies to control the overall amount of QoS authorized for the AF.

In an example, the NEF may interact with the PCF by triggering a Npcf_PolicyAuthorization_Create request and may provide at least one of the DetNet node ID, the DetNet parameter, the DetNet flow id, the DetNet flow assistance information, the DetNet management container, UE address, AF Identifier, Flow description(s), the QoS Reference and the optional Alternative Service Requirements.

In an example, if the NEF receives any of the individual QoS parameters for a DetNet flow or DetNet node, from the AF, the NEF may forward these received individual QoS parameters in the Ntsctsf_QoSandTSCAssistance_Create request message to the TSCTSF. If the AF is considered to be trusted by the operator, the AF uses the Ntsctsf_QoSandTSCAssistance_Create request message to interact directly with TSCTSF to request reserving resources for an AF session. A TSCTSF address may be locally configured (e.g., per DetNet domain, a single TSCTSF per DNN/S-NSSAI, and/or the like) in the NEF, PCF and trusted AF. Alternatively, the TSCTSF may be discovered from the NRF. The TSCTSF may interacts with the PCF by triggering a Npcf_PolicyAuthorization_Update request and may provide at least one of the DetNet parameter, the DetNet flow id, the DetNet flow assistance information, the DetNet management container, UE address, AF Identifier, Flow description(s), the QoS Reference, Individual QoS Parameters and the optional Alternative Service Requirements.

In an example, the TSCTSF may perform calculation of required DetNet resources based on an element of the DetNet parameter. If the TSCTSF receives a DetNet parameter, or a QoS parameter associated with a DetNet node or DetNet flow, the TSCTSF may calculate a Requested PDB by subtracting the UE-DS-T Residence Time, or DS-TT residence time, provided by the PCF (if available), from the Requested 5GS delay. In an example, the TSCTSF may determine or modify the DetNet assistance information, the DetNet management container, the DetNet parameter, and/or the like. If the TSCTSF receives any of the following individual QoS parameters: flow direction, Burst Arrival Time, Periodicity, Time domain, Survival Time from the NEF, then the TSCTSF determines the TSC Assistance Container and sends it together with the Requested PDB, the TSC Assistance Container, and other received individual QoS parameters in the Npcf_PolicyAuthorization_Update request to the PCF. In an example, the TSCTSF may discover the PCF in case the TSCTSF has not received any notification from PCF (e.g. no UE-DS-TT Residence time), TSCTSF sends the Requested PDB, the DetNet assistance information, the DetNet parameter, the DetNet management container, the TSC Assistance Container, and other received individual QoS and Alternative QoS Related parameters to the PCF.

In an example, if the PCF or TSCTSF authorize request from the NEF, the PCF or the TSCTSF may send a request to a SMF, or a UPF to configure the UPF. In an example, the NEF may send a configuration message to the UPF by employing UPF services such as Nupf messages.

In an example, if the PCF determines that the SMF needs updated policy information, the PCF may send/issue a Npcf_SMPolicyControl_UpdateNotify request with updated policy information about the PDU Session as described in the PCF initiated SM Policy Association Modification procedure. In an example, the PDU session may be a PDU session serving the DetNet flow, or serving the DetNet node.

If the request is authorized, the PCF derives the required QoS parameters based on the information provided by the TSCTSF and determines whether this QoS is allowed (according to the PCF configuration), and notifies the result to the TSCTSF. In addition, if the Alternative Service Requirements are provided, the PCF derives the Alternative QoS parameter set(s) from the one or more QoS reference parameters (if provided) contained in the Alternative Service Requirements in the same prioritized order.

If the PCF receives the individual QoS parameters instead of QoS Reference, the PCF sets the PDB and MDBV according to the received Requested PDB and Burst Size received from the TSCTSF. If the Requested PDB is not provided, the PCF determines the PDB that matches the QoS Reference. It also sets the GFBR and MFBR according to requested values sent by the TSCTSF. The PCF may use the Requested Priority from the AF to determine QoS Flow Priority.

The TSCTSF may send a Ntsctsf_QoSandTSCAssistance_Create response message (Transaction Reference ID, Result) to the NEF. Result indicates whether the request is granted or not. If the AF is considered to be trusted by the operator, the TSCTSF may send the Ntsctsf_QoSandTSCAssistance_Create response message directly to AF. In an example, the NEF may send a Nnef_AFsessionWithQoS_Create response message (Transaction Reference ID, Result) to the AF. Result indicates whether the request is granted or not.

The NEF may send a Npcf_PolicyAuthorization_Subscribe message to the PCF to subscribe to notifications of Resource allocation status and may subscribe to other events. The TSCTSF may send a Npcf_PolicyAuthorization_Subscribe message to the PCF to subscribe to notifications of Resource allocation status and may subscribe to other events. When the event condition is met, e.g. that the establishment of the transmission resources corresponding to the QoS update succeeded or failed, the PCF sends Npcf_PolicyAuthorization_Notify message to the NEF notifying about the event. If the AF is considered to be trusted by the operator, the PCF sends the Npcf_PolicyAuthorization_Notify message directly to AF. When the event condition is met, e.g. that the establishment of the transmission resources corresponding to the QoS update succeeded or failed, the PCF sends Npcf_PolicyAuthorization_Notify message to the TSCTSF notifying about the event. The TSCTSF sends Ntsctsf_QoSandTSCAssistance_Notify message with the event reported by the PCF to the NEF. If the AF is considered to be trusted by the operator, the TSCTSF sends the Ntsctsf_QoSandTSCAssistance_Notify message directly to AF. The NEF may send Nnef_AFsessionWithQoS_Notify message with the event reported by the PCF to the AF.

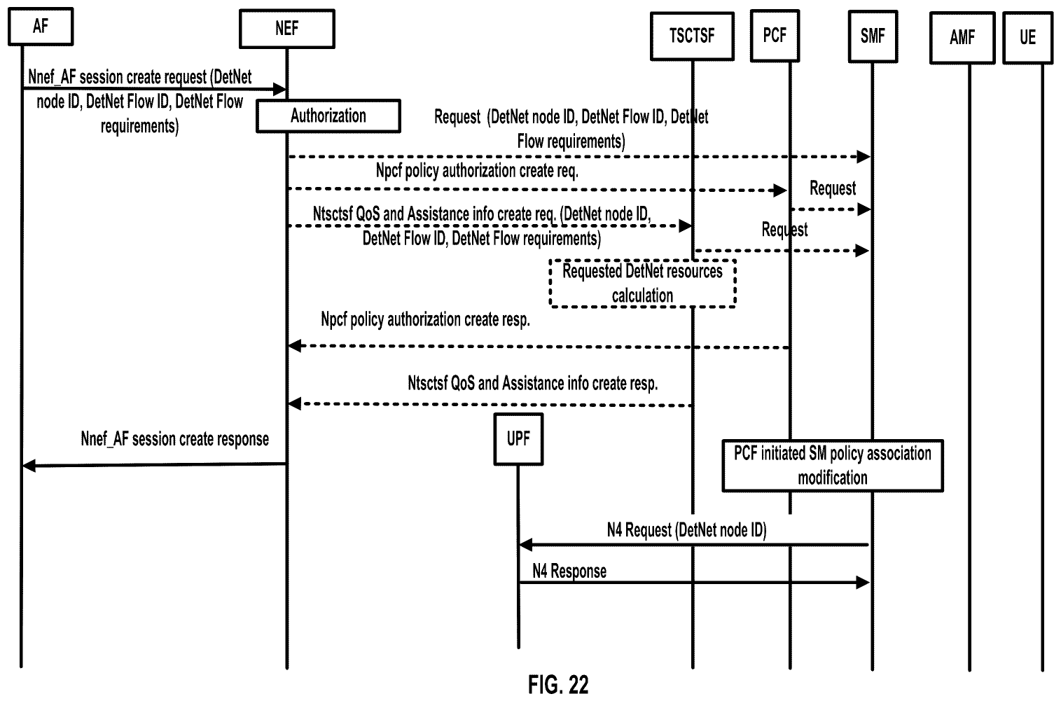

FIG. 22 illustrates an example user plane configuration procedure in a network in accordance with embodiments of the present disclosure. In an example embodiment, the SMF may receive a message from the PCF, NEF or from the TSCTSF, indicating a request for DetNet resources associated with a DetNet flow. In an example, the SMF may receive a policy update message. In an example, when the SMF receives the request the SMF may determine to configure the UPF for the DetNet node. In an example, the configuration may be at a session level. In an example, the configuration may be at a node level. In an example, the SMF may determine a PDU session that serves the DetNet node or the DetNet flow. In an example, the SMF may determine an N4 session associated with the PDU session. The SMF may send an N4 request to the UPF. In an example, the N4 request may be an N4 session modification request, N4 session establishment request, an PFCP session modification request, a PFCP session establishment request, and/or the like. In an example, the N4 request may be an N4 association request, a PFCP association request, and/or the like. In an example, the N4 request may comprise at least one of the DetNet node ID, the DetNet parameter, the DetNet flow id, the DetNet flow assistance information, the DetNet management container, and/or the like. In an example the N4 request may comprise a packet detection rule (PDR). In an example, the PDR may comprise at least one of the DetNet node ID, the DetNet parameter, the DetNet flow id, the DetNet flow assistance information, the DetNet management container, and/or the like. In an example embodiment, the UPF may send an N4 response to the SMF indicating acceptance or rejection of the N4 request.

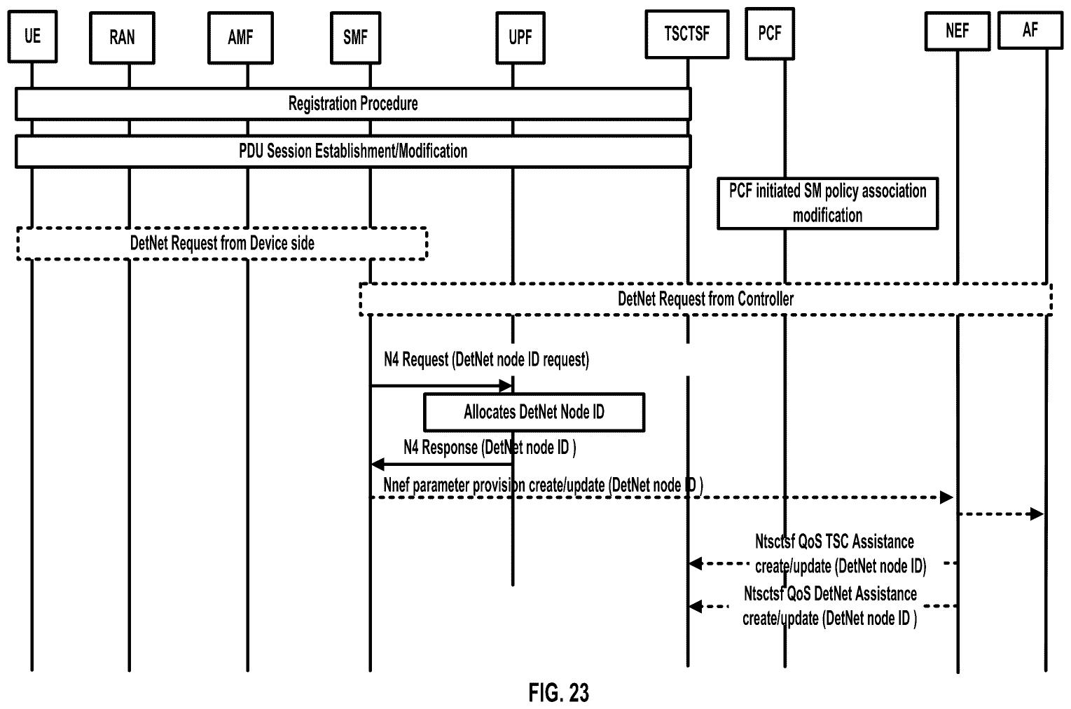

FIG. 23 illustrates an example DetNet configuration procedure in a network in accordance with embodiments of the present disclosure. In an example, the SMF may receive a request for establishment of a DetNet flow, or creation/configuration of a DetNet node as per an example embodiment described above. In an example, the SMF may send an N4 request to the UPF indicating a request to allocate a DetNet node ID. In an example, the N4 request may be an N4 session modification/establishment request, a PFCP session modification/establishment message, and, or the like. In an example, the N4 request may be an N4 association request, a PFCP association request message, and, or the like. In an example, the UPF may allocate or determine a DetNet node ID. The UPF may send an N4 response to the SMF that may comprise the DetNet node ID. In an example, the UPF may send a message to the NEF wherein the message may comprise the DetNet node ID. In an example, the message may be an Nnef parameter provision create/update message. In an example, the NEF may send the provisioned parameters to the AF or the DetNet control entity. In an example, the NEF may send to the TSCTSF a message (e.g., Ntsctsf QoS update/create message) comprising the DetNet node ID.

In an example embodiment, a port management information container may comprise the following:

| | Applicability | | Supported | Supported | |
|---|---|---|---|---|---|
| | (see NOTE 6) | | operations by | operations | |
| | DS- | NW- | TSN AF | by TSCTSF | |
| Port management information | TT | TT | (see NOTE 1) | (see NOTE 1) | Reference |
| General | | | | | |
| Port management capabilities (see NOTE 2) | X | X | R | R | |
| Bridge delay related information | | | | | |
| txPropagationDelay | X | X | R | — | IEEE Std 802.1Qcc [95] |
| | | | | | clause 12.32.2.1 |
| txPropagationDelayDeltaThreshold (see | X | X | RW | | |
| NOTE 23) | | | | | |
| Traffic class related information | | | | | |
| Traffic class table | X | X | RW | — | IEEE Std 802.1Q [98] |
| | | | | | clause 12.6.3 and |
| | | | | | clause 8.6.6. |
| Gate control information | | | | | |
| GateEnabled | X | X | RW | — | IEEE Std 802.1Q [98] |
| | | | | | Table 12-29 |
| AdminBaseTime | X | X | RW | — | IEEE Std 802.1Q [98] |
| | | | | | Table 12-29 |
| AdminControlList | X | X | RW | — | IEEE Std 802.1Q [98] |
| | | | | | Table 12-29 |
| AdminCycleTime (see NOTE 3) | X | X | RW | — | IEEE Std 802.1Q [98] |
| | | | | | Table 12-29 |
| AdminControlListLength (see NOTE 3) | X | X | RW | — | IEEE Std 802.1Q [98] |
| | | | | | Table 12-29 |
| AdminCycleTimeExtension | X | X | RW | — | IEEE Std 802.1Q [98] |
| | | | | | Table 12-29 |
| Tick granularity | X | X | R | — | IEEE Std 802.1Q [98] |
| | | | | | Table 12-29 |
| SupportedListMax | X | X | R | — | IEEE Std 802.1Q [98] |
| | | | | | Table 12-29 |
| General Neighbor discovery | | | | | |
| configuration | | | | | |
| (NOTE 4) | | | | | |
| adminStatus | D | X | RW | — | IEEE Std 802.1AB [97] |
| | | | | | clause 9.2.5.1 |
| lldpV2LocChassisIdSubtype | D | X | RW | — | IEEE Std 802.1AB [97] |
| | | | | | Table 11-2 |
| lldpV2LocChassisId | D | X | RW | — | IEEE Std 802.1AB [97] |
| | | | | | Table 11-2 |
| lldpV2MessageTxInterval | D | X | RW | — | IEEE Std 802.1AB [97] |
| | | | | | Table 11-2 |
| lldpV2MessageTxHoldMultiplier | D | X | RW | — | IEEE Std 802.1AB [97] |
| | | | | | Table 11-2 |
| NW-TT port neighbor discovery | | | | | |
| configuration | | | | | |
| lldpV2LocPortIdSubtype | | X | RW | — | IEEE Std 802.1AB [97] |
| | | | | | Table 11-2 |
| lldpV2LocPortId | | X | RW | — | IEEE Std 802.1AB [97] |
| | | | | | Table 11-2 |
| DS-TT port neighbor discovery | | | | | |
| configuration | | | | | |
| lldpV2LocPortIdSubtype | D | | RW | — | IEEE Std 802.1AB [97] |
| | | | | | Table 11-2 |
| lldpV2LocPortId | D | | RW | — | IEEE Std 802.1AB [97] |
| | | | | | Table 11-2 |
| Neighbor discovery information for each | | | | | |
| discovered neighbor of NW-TT (NOTE 26) | | | | | |
| lldpV2RemChassisIdSubtype | | X | R | — | IEEE Std 802.1AB [97] |
| | | | | | Table 11-2 |
| lldpV2RemChassisId | | X | R | — | IEEE Std 802.1AB [97] |
| | | | | | Table 11-2 |
| lldpV2RemPortIdSubtype | | X | R | — | IEEE Std 802.1AB [97] |
| | | | | | Table 11-2 |
| lldpV2RemPortId | | X | R | — | IEEE Std 802.1AB [97] |
| | | | | | Table 11-2 |
| TTL | | X | R | — | IEEE Std 802.1AB [97] |
| | | | | | clause 8.5.4 |
| Neighbor discovery information for each | | | | | |
| discovered neighbor of DS-TT | | | | | |
| (NOTE 5) | | | | | |
| lldpV2RemChassisIdSubtype | D | | R | — | IEEE Std 802.1AB [97] |
| | | | | | Table 11-2 |
| lldpV2RemChassisId | D | | R | — | IEEE Std 802.1AB [97] |
| | | | | | Table 11-2 |
| lldpV2RemPortIdSubtype | D | | R | — | IEEE Std 802.1AB [97] |
| | | | | | Table 11-2 |
| lldpV2RemPortId | D | | R | — | IEEE Std 802.1AB [97] |
| | | | | | Table 11-2 |
| TTL | D | | R | — | IEEE Std 802.1AB [97] |
| | | | | | clause 8.5.4.1 |
| Stream Parameters | | | | | |
| (NOTE 11) | | | | | |
| MaxStreamFilterInstances | X | | R | — | IEEE Std 802.1Q [98] |
| | | | | | clause 12.31.1.1 |
| MaxStreamGateInstances | X | | R | — | IEEE Std 802.1Q [98] |
| | | | | | clause 12.31.1.2 |
| MaxFlowMeterInstances | X | | R | — | IEEE Std 802.1Q [98] |
| | | | | | clause 12.31.1.3 |
| SupportedListMax | X | | R | — | IEEE Std 802.1Q [98] |
| | | | | | clause 12.31.1.4 |
| Per-Stream Filtering and Policing | | | | | |
| information | | | | | |
| (NOTE 10) | | | | | |
| Stream Filter Instance Table | | | | — | IEEE Std 802.1Q [98] |
| (NOTE 8) | | | | | Table 12-32 |
| > StreamFilterInstanceIndex | X | X | RW | — | IEEE Std 802.1Q [98] |
| | | | | | Table 12-32 |
| > Stream Identification type | X | X | RW | — | IEEE 802.1CB [83] |
| | | | | | clause 9.1.1.6 |
| > Stream Identification Controlling | X | X | RW | — | IEEE 802.1CB [83] |
| Parameters | | | | | clauses 9.1.2, 9.1.3, |
| | | | | | 9.1.4 |
| | | | | | (NOTE 12) |
| > PrioritySpec | X | X | RW | — | IEEE Std 802.1Q [98] |
| | | | | | Table 12-32 |
| > StreamGateInstanceID | X | X | RW | — | IEEE Std 802.1Q [98] |
| | | | | | Table 12-32 |
| Stream Gate Instance Table | | | | | IEEE Std 802.1Q [98] |
| (NOTE 9) | | | | | Table 12-33 |
| StreamGateInstanceIndex | X | X | RW | — | IEEE Std 802.1Q [98] |
| | | | | | Table 12-33 |
| PSFPAdminBaseTime | X | X | RW | — | IEEE Std 802.1Q [98] |
| | | | | | Table 12-33 |
| PSFPAdminControlList | X | X | RW | — | IEEE Std 802.1Q [98] |
| | | | | | Table 12-33 |
| PSFPAdminCycleTime | X | X | RW | — | IEEE Std 802.1Q [98] |
| | | | | | Table 12-33 |
| PSFPTickGranularity | X | X | R | — | IEEE Std 802.1Q [98] |
| | | | | | Table 12-33 |
| PSFPAdminCycleTimeExtension | X | X | R | — | IEEE Std 802.1Q [98] |
| | | | | | Table 12-33 |
| Time Synchronization Information | | | | | |
| TSN Time domain number (NOTE 24) | X | X | RW | | |
| Supported PTP instance types (NOTE 13) | X | | R | R | IEEE Std 1588 [126] |
| | | | | | clause 8.2.1.5.5 |
| Supported transport types (NOTE 14) | X | | R | R | |
| Supported delay mechanisms (NOTE 15) | X | | R | R | IEEE Std 1588 [126] |
| | | | | | clause 8.2.15.4.4 |
| PTP grandmaster capable (NOTE 16) | X | | R | R | |
| gPTP grandmaster capable (NOTE 17) | X | | R | R | |
| Supported PTP profiles (NOTE 18) | X | | R | R | |
| Number of supported PTP instances | X | | R | R | |
| PTP instance specification | | | | | |
| PTP Instance ID (NOTE 25) | X | X | RW | RW | |
| > PTP profile (NOTE 19) | X | | RW | RW | |
| > Transport type (NOTE 20) | X | | RW | RW | |
| > Grandmaster enabled (NOTE 21) | X | | RW | RW | |
| IEEE Std 1588 [126] data sets (NOTE 22) | | | | | |
| > defaultDS.clockIdentity | X | | RW | RW | IEEE Std 1588 [126] |
| | | | | | clause 8.2.1.2.2 |
| > defaultDS.clockQuality.clockClass | X | | RW | RW | IEEE Std 1588 [126] |
| | | | | | clause 8.2.1.3.1.2 |
| > defaultDS.clockQuality.clockAccuracy | X | | RW | RW | IEEE Std 1588 [126] |
| | | | | | clause 8.2.1.3.1.3 |
| > defaultDS.clockQuality.offsetScaledLogVariance | X | | RW | RW | IEEE Std 1588 [126] |
| | | | | | clause 8.2.1.3.1.4 |
| > defaultDS.priority1 | X | | RW | RW | IEEE Std 1588 [126] |
| | | | | | clause 8.2.1.4.1 |
| > defaultDS.priority2 | X | | RW | RW | IEEE Std 1588 [126] |
| | | | | | clause 8.2.1.4.2 |
| > defaultDS.domainNumber | X | | RW | RW | IEEE Std 1588 [126] |
| | | | | | clause 8.2.1.4.3 |
| > defaultDS.sdold | X | | RW | RW | IEEE Std 1588 [126] |
| | | | | | clause 8.2.1.4.5 |
| > defaultDS.instanceEnable | X | | RW | RW | IEEE Std 1588 [126] |
| | | | | | clause 8.2.1.5.2 |
| > defaultDS.instanceType | X | | RW | RW | IEEE Std 1588 [126] |
| | | | | | clause 8.2.1.5.5 |
| > portDS.portIdentity | X | X | RW | RW | IEEE Std 1588 [126] |
| | | | | | clause 8.2.15.2.1 |
| > portDS.portState | X | X | R | R | IEEE Std 1588 [126] |
| | | | | | clause 8.2.15.3.1 |
| > portDS.logMinDelayReqInterval | X | X | RW | RW | IEEE Std 1588 [126] |
| | | | | | clause 8.2.15.3.2 |
| > portDS.logAnnounceInterval | X | X | RW | RW | IEEE Std 1588 [126] |
| | | | | | clause 8.2.15.4.1 |
| > portDS.announceReceiptTimeout | | X | RW | RW | IEEE Std 1588 [126] |
| | | | | | clause 8.2.15.4.2 |
| > portDS.logSyncInterval | X | X | RW | RW | IEEE Std 1588 [126] |
| | | | | | clause 8.2.15.4.3 |
| > portDS.delayMechanism | X | X | RW | RW | IEEE Std 1588 [126] |
| | | | | | clause 8.2.15.4.4 |
| > portDS.logMinPdelayReqInterval | X | X | RW | RW | IEEE Std 1588 [126] |
| | | | | | clause 8.2.15.4.5 |
| > portDS.versionNumber | X | X | RW | RW | IEEE Std 1588 [126] |
| | | | | | clause 8.2.15.4.6 |
| > portDS.minorVersionNumber | X | X | RW | RW | IEEE Std 1588 [126] |
| | | | | | clause 8.2.15.4.7 |
| > portDS.delayAsymmetry | X | X | RW | RW | IEEE Std 1588 [126] |
| | | | | | clause 8.2.15.4.8 |
| > portDS.portEnable | X | X | RW | RW | IEEE Std 1588 [126] |
| | | | | | clause 8.2.15.5.1 |
| > timePropertiesDS.currentUtcOffset | X | | RW | RW | IEEE Std 1588 [126] |
| | | | | | clause 8.2.4.2 |
| > timePropertiesDS.timeSource | X | | RW | RW | IEEE Std 1588 [126] |
| | | | | | clause 8.2.4.9 |
| > externalPortConfigurationPortDS.desiredState | | | RW | RW | IEEE Std 1588 [126] |
| | | | | | clause 15.5.3.7.15.1 |
| IEEE Std 802.1AS [104] data sets | | | | | |
| (NOTE 22) | | | | | |
| > defaultDS.clockIdentity | X | | RW | RW | IEEE Std 802.1AS [104] |
| | | | | | clause 14.2.2 |
| > defaultDS.clockQuality.clockClass | X | | RW | RW | IEEE Std 802.1AS [104] |
| | | | | | clause 14.2.4.2 |
| > defaultDS.clockQuality.clockAccuracy | X | | RW | RW | IEEE Std 802.1AS [104] |
| | | | | | clause 14.2.4.3 |
| > defaultDS.clockQuality.offsetScaledLogVariance | X | | RW | RW | IEEE Std 802.1AS [104] |
| | | | | | clause 14.2.4.4 |
| > defaultDS.priority1 | X | | RW | RW | IEEE Std 802.1AS [104] |
| | | | | | clause 14.2.5 |
| > defaultDS.priority2 | X | | RW | RW | IEEE Std 802.1AS [104] |
| | | | | | clause 14.2.6 |
| > defaultDS.timeSource | X | | RW | RW | IEEE Std 802.1AS [104] |
| | | | | | clause 14.2.15 |
| > defaultDS.domainNumber | X | | RW | RW | IEEE Std 802.1AS [104] |
| | | | | | clause 14.2.16 |
| > defaultDS.sdold | X | | RW | RW | IEEE Std 802.1AS [104] |
| | | | | | clause 14.2.4.3 |
| > defaultDS.instanceEnable | X | | RW | RW | IEEE Std 802.1AS [104] |
| | | | | | clause 14.2.19 |
| > portDS.portIdentity | | X | RW | RW | IEEE Std 802.1AS [104] |
| | | | | | clause 14.8.2 |
| > portDS.portState | | X | R | R | IEEE Std 802.1AS [104] |
| | | | | | clause 14.8.3 |
| > portDS.ptpPortEnabled | X | X | RW | RW | IEEE Std 802.1AS [104] |
| | | | | | clause 14.8.4 |
| > portDS.delayMechanism | X | X | RW | RW | IEEE Std 802.1AS [104] |
| | | | | | clause 14.8.5 |
| > portDS.isMeasuringDelay | X | X | R | R | IEEE Std 802.1AS [104] |
| | | | | | clause 14.8.6 |
| > portDS.asCapable | X | X | R | R | IEEE Std 802.1AS [104] |
| | | | | | clause 14.8.7 |
| > portDS.meanLinkDelay | X | X | R | R | IEEE Std 802.1AS [104] |
| | | | | | clause 14.8.8 |
| > portDS.meanLinkDelayThresh | X | X | RW | RW | IEEE Std 802.1AS [104] |
| | | | | | clause 14.8.9 |
| > portDS.delayAsymmetry | X | X | RW | RW | IEEE Std 802.1AS [104] |
| | | | | | clause 14.8.10 |
| > portDS.neighborRateRatio | X | X | R | R | IEEE Std 802.1AS [104] |
| | | | | | clause 14.8.11 |
| > portDS.initialLogAnnounceInterval | X | X | RW | RW | IEEE Std 802.1AS [104] |
| | | | | | clause 14.8.12 |
| > portDS.currentLogAnnounceInterval | X | X | R | R | IEEE Std 802.1AS [104] |
| | | | | | clause 14.8.13 |
| > portDS.useMgtSettableLogAnnounceInterval | X | X | RW | RW | IEEE Std 802.1AS [104] |
| | | | | | clause 14.8.14 |
| > portDS.mgtSettableLogAnnounceInterval | X | X | RW | RW | IEEE Std 802.1AS [104] |
| | | | | | clause 14.8.15 |
| > portDS.announceReceiptTimeout | | X | RW | RW | IEEE Std 802.1AS [104] |
| | | | | | clause 14.8.16 |
| > portDS.initialLogSyncInterval | X | X | RW | RW | IEEE Std 802.1AS [104] |
| | | | | | clause 14.8.17 |
| > portDS.currentLogSyncInterval | X | X | R | R | IEEE Std 802.1AS [104] |
| | | | | | clause 14.8.18 |
| > portDS.useMgtSettableLogSyncInterval | X | X | RW | RW | IEEE Std 802.1AS [104] |
| | | | | | clause 14.8.19 |
| > portDS.mgtSettableLogSyncInterval | X | X | RW | RW | IEEE Std 802.1AS [104] |
| | | | | | clause 14.8.20 |
| > portDS.syncReceiptTimeout | | X | RW | RW | IEEE Std 802.1AS [104] |
| | | | | | clause 14.8.21 |
| > portDS.syncReceiptTimeoutTimeInterval | | X | RW | RW | IEEE Std 802.1AS [104] |
| | | | | | clause 14.8.22 |
| > portDS.initialLogPdelayReqInterval | X | X | RW | RW | IEEE Std 802.1AS [104] |
| | | | | | clause 14.8.23 |
| > portDS.currentLogPdelayReqInterval | X | X | R | R | IEEE Std 802.1AS [104] |
| | | | | | clause 14.8.24 |
| > portDS.useMgtSettableLogPdelayReqInterval | X | X | RW | RW | IEEE Std 802.1AS [104] |
| | | | | | clause 14.8.25 |
| > portDS.mgtSettableLogPdelayReqInterval | X | X | RW | RW | IEEE Std 802.1AS [104] |
| | | | | | clause 14.8.26 |
| > portDS.initialLogGptpCapableMessageInterval | X | X | RW | RW | IEEE Std 802.1AS [104] |
| | | | | | clause 14.8.27 |
| > portDS.currentLogGptpCapableMessageInterval | X | X | R | R | IEEE Std 802.1AS [104] |
| | | | | | clause 14.8.28 |
| > portDS.useMgtSettableLogGptpCapableMessageInterval | X | X | RW | RW | IEEE Std 802.1AS [104] |
| | | | | | clause 14.8.29 |
| > portDS.mgtSettableLogGptpCapableMessageInterval | X | X | RW | RW | IEEE Std 802.1AS [104] |
| | | | | | clause 14.8.30 |
| > portDS.initialComputeNeighborRateRatio | X | X | RW | RW | IEEE Std 802.1AS [104] |
| | | | | | clause 14.8.31 |
| > portDS.currentComputeNeighborRateRatio | X | X | R | R | IEEE Std 802.1AS [104] |
| | | | | | clause 14.8.32 |
| > portDS.useMgtSettableComputeNeighborRateRatio | X | X | RW | RW | IEEE Std 802.1AS [104] |
| | | | | | clause 14.8.33 |
| > portDS.mgtSettableComputeNeighborRateRatio | X | X | RW | RW | IEEE Std 802.1AS [104] |
| | | | | | clause 14.8.34 |
| > portDS.initialComputeMeanLinkDelay | X | X | RW | RW | IEEE Std 802.1AS [104] |
| | | | | | clause 14.8.35 |
| > portDS.currentComputeMeanLinkDelay | X | X | R | R | IEEE Std 802.1AS [104] |
| | | | | | clause 14.8.36 |
| > portDS.useMgtSettableComputeMeanLinkDelay | X | X | RW | RW | IEEE Std 802.1AS [104] |
| | | | | | clause 14.8.37 |
| > portDS.mgtSettableComputeMeanLinkDelay | X | X | RW | RW | IEEE Std 802.1AS [104] |
| | | | | | clause 14.8.38 |
| > portDS.allowedLostResponses | X | X | RW | RW | IEEE Std 802.1AS [104] |
| | | | | | clause 14.8.39 |
| > portDS.allowedFaults | X | X | RW | RW | IEEE Std 802.1AS [104] |
| | | | | | clause 14.8.40 |
| > portDS.gPtpCapableReceiptTimeout | X | X | RW | RW | IEEE Std 802.1AS [104] |
| | | | | | clause 14.8.41 |
| > portDS.versionNumber | X | X | RW | RW | IEEE Std 802.1AS [104] |
| | | | | | clause 14.8.42 |
| > portDS.nup | X | X | RW | RW | IEEE Std 802.1AS [104] |
| | | | | | clause 14.8.43 |
| > portDS.ndown | X | X | RW | RW | IEEE Std 802.1AS [104] |
| | | | | | clause 14.8.44 |
| > portDS.oneStepTxOper | X | X | R | R | IEEE Std 802.1AS [104] |
| | | | | | clause 14.8.45 |
| > portDS.oneStepReceive | X | X | R | R | IEEE Std 802.1AS [104] |
| | | | | | clause 14.8.46 |
| > portDS.oneStepTransmit | X | X | R | R | IEEE Std 802.1AS [104] |
| | | | | | clause 14.8.47 |
| > portDS.initialOneStepTxOper | X | X | RW | RW | IEEE Std 802.1AS [104] |
| | | | | | clause 14.8.48 |
| > portDS.currentOneStepTxOper | X | X | RW | RW | IEEE Std 802.1AS [104] |
| | | | | | clause 14.8.49 |
| > portDS.useMgtSettableOneStepTxOper | X | X | RW | RW | IEEE Std 802.1AS [104] |
| | | | | | clause 14.8.50 |
| > portDS.mgtSettableOneStepTxOper | X | X | RW | RW | IEEE Std 802.1AS [104] |
| | | | | | clause 14.8.51 |
| > portDS.syncLocked | X | X | R | R | IEEE Std 802.1AS [104] |
| | | | | | clause 14.8.52 |
| > portDS.pdelayTruncatedTimestampsArray | X | X | RW | RW | IEEE Std 802.1AS [104] |
| | | | | | clause 14.8.53 |
| > portDS.minorVersionNumber | X | X | RW | RW | IEEE Std 802.1AS [104] |
| | | | | | clause 14.8.54 |
| > timePropertiesDS.currentUtcOffset | X | | RW | RW | IEEE Std 802.1AS [104] |
| | | | | | clause 14.5.2 |
| > externalPortConfigurationPortDS.desiredState | | X | RW | RW | IEEE Std 802.1AS [104] |
| | | | | | clause 14.12.2 |

In an example embodiment, a user plane node management information container may comprise the following:

| | Supported | Supported | |
|---|---|---|---|
| | operations by | operations | |
| | TSN AF | by TSCTSF | |
| User plane node management information | (see NOTE 1) | (see NOTE 1) | Reference |
| Information for 5GS Bridge | | | |
| User plane node Address | R | R | |
| User plane node ID | R | R | |
| NW-TT port numbers | R | R | |
| Traffic forwarding information | | | |
| Static Filtering Entry (NOTE 3) | RW | — | IEEE Std 802.1Q [98] |
| | | | clause 8.8.1 |
| General Neighbor discovery configuration | | | |
| (NOTE 2) | | | |
| adminStatus | RW | — | IEEE Std 802.1AB [97] |
| | | | clause 9.2.5.1 |
| lldpV2LocChassisIdSubtype | RW | — | IEEE Std 802.1AB [97] |
| | | | Table 11-2 |
| lldpV2LocChassisId | RW | — | IEEE Std 802.1AB [97] |
| | | | Table 11-2 |
| lldpV2MessageTxInterval | RW | — | EEE Std 802.1AB [97] |
| | | | Table 11-2 |
| lldpV2MessageTxHoldMultiplier | RW | — | IEEE Std 802.1AB [97] |
| | | | Table 11-2 |
| DS-TT port neighbor discovery configuration for DS-TT | | | |
| ports (NOTE 4) | | | |
| >DS-TT port neighbor discovery configuration for each | | | |
| DS-TT port | | | |
| >> DS-TT port number | RW | — | |
| >> lldpV2LocPortIdSubtype | RW | — | IEEE Std 802.1AB [97] |
| | | | Table 11-2 |
| >> lldpV2LocPortId | RW | — | EEE Std 802.1AB [97] |
| | | | Table 11-2 |
| Discovered neighbor information for DS-TT ports | | | |
| (NOTE 4) | | | |
| >Discovered neighbor information for each DS-TT port | | | |
| (NOTE 4) | | | |
| >> DS-TT port number | R | — | |
| >> lldpV2RemChassisIdSubtype | R | — | IEEE Std 802.1AB [97] |
| | | | Table 11-2 |
| >> lldpV2RemChassisId | R | — | IEEE Std 802.1AB [97] |
| | | | Table 11-2 |
| >> lldpV2RemPortIdSubtype | R | — | IEEE Std 802.1AB [97] |
| | | | Table 11-2 |
| >> lldpV2RemPortId | R | — | IEEE Std 802.1AB [97] |
| | | | Table 11-2 |
| >> TTL | R | — | IEEE Std 802.1AB [97] |
| | | | clause 8.5.4.1 |
| Stream Parameters (NOTE 5) | | | |
| MaxStreamFilterInstances | R | — | IEEE Std 802.1Q [98] |
| MaxStreamGateInstances | R | — | IEEE Std 802.1Q [98] |
| MaxFlowMeterInstances | R | — | IEEE Std 802.1Q [98] |
| SupportedListMax | R | — | IEEE Std 802.1Q [98] |
| Time synchronization information | | | |
| Supported PTP instance types (NOTE 6) | R | R | |
| Supported transport types (NOTE 7) | R | R | |
| Supported delay mechanisms (NOTE 8) | R | R | |
| PTP grandmaster capable (NOTE 9) | R | R | |
| gPTP grandmaster capable (NOTE 10) | R | R | |
| Supported PTP profiles (NOTE 11) | R | R | |
| Number of supported PTP instances | R | R | |
| Time synchronization information for PTP instances | | | |
| (NOTE 16) | | | |
| > PTP instance specification | | | |
| >> PTP Instance ID (NOTE 17) | RW | RW | |
| >> PTP profile (NOTE 12) | RW | RW | |
| >> Transport type (NOTE 13) | RW | RW | |
| >> Grandmaster candidate enabled | RW | RW | |
| IEEE Std 1588 [126] data sets (NOTE 15) | | | |
| >> defaultDS.clockIdentity | RW | RW | IEEE Std 1588 [126] |
| | | | clause 8.2.1.2.2 |
| >> defaultDS.clockQuality.clockClass | RW | RW | IEEE Std 1588 [126] |
| | | | clause 8.2.1.3.1.2 |
| >> defaultDS.clockQuality.clockAccuracy | RW | RW | IEEE Std 1588 [126] |
| | | | clause 8.2.1.3.1.3 |
| >> defaultDS.clockQuality.offsetScaledLogVariance | RW | RW | IEEE Std 1588 [126] |
| | | | clause 8.2.1.3.1.4 |
| >> defaultDS.priority1 | RW | RW | IEEE Std 1588 [126] |
| | | | clause 8.2.1.4.1 |
| >> defaultDS.priority2 | RW | RW | IEEE Std 1588 [126] |
| | | | clause 8.2.1.4.2 |
| >> defaultDS.domainNumber | RW | RW | IEEE Std 1588 [126] |
| | | | clause 8.2.1.4.3 |
| >> defaultDS.sdold | RW | RW | IEEE Std 1588 [126] |
| | | | clause 8.2.1.4.5 |
| >> defaultDS.instanceEnable | RW | RW | IEEE Std 1588 [126] |
| | | | clause 8.2.1.5.2 |
| >> defaultDS.externalPortConfigurationEnabled | RW | RW | IEEE Std 1588 [126] |
| | | | clause 8.2.1.5.3 |
| >> defaultDS.instanceType | RW | RW | IEEE Std 1588 [126] |
| | | | clause 8.2.1.5.5 |
| >> timePropertiesDS.currentUtcOffset | RW | RW | IEEE Std 1588 [126] |
| | | | clause 8.2.4.2 |
| >> timePropertiesDS.timeSource | RW | RW | IEEE Std 1588 [126] |
| | | | clause 8.2.4.9 |
| IEEE Std 802.1AS [104] data sets (NOTE 15) | | | |
| >> defaultDS.clockIdentity | RW | RW | IEEE Std 802.1AS [104] |
| | | | clause 14.2.2 |
| >> defaultDS.clockQuality.clockClass | RW | RW | IEEE Std 802.1AS [104] |
| | | | clause 14.2.4.2 |
| >> defaultDS.clockQuality.clockAccuracy | RW | RW | IEEE Std 802.1AS [104] |
| | | | clause 14.2.4.3 |
| >> defaultDS.clockQuality.offsetScaledLogVariance | RW | RW | IEEE Std 802.1AS [104] |
| | | | clause 14.2.4.4 |
| >> defaultDS.priority1 | RW | RW | IEEE Std 802.1AS [104] |
| | | | clause 14.2.5 |
| >> defaultDS.priority2 | RW | RW | IEEE Std 802.1AS [104] |
| | | | clause 14.2.6 |
| >> defaultDS.timeSource | RW | RW | IEEE Std 802.1AS [104] |
| | | | clause 14.2.15 |
| >> defaultDS.domainNumber | RW | RW | IEEE Std 802.1AS [104] |
| | | | clause 14.2.16 |
| >> defaultDS.sdold | RW | RW | IEEE Std 802.1AS [104] |
| | | | clause 14.2.18 |
| >> defaultDS.externalPortConfigurationEnabled | RW | RW | IEEE Std 802.1AS [104] |
| | | | clause 14.2.4.3 |
| >> defaultDS.instanceEnable | RW | RW | IEEE Std 802.1AS [104] |
| | | | clause 14.2.19 |
| >> timePropertiesDS.currentUtcOffset | RW | RW | IEEE Std 802.1AS [104] |
| | | | clause 14.5.2 |
| Time synchronization information for DS-TT ports | | | |
| > Time synchronization information for each DS-TT port | | | |
| > DS-TT port number | RW | RW | |
| >> Time synchronization information for each PTP | | | |
| Instance | | | |
| >> PTP Instance ID (NOTE 17) | RW | RW | |
| >> Grandmaster on behalf of DS-TT enabled (NOTE 14) | RW | RW | |
| IEEE Std 1588 [126] data sets (NOTE 15) | | | |
| >> portDS.portIdentity | RW | RW | IEEE Std 1588 [126] |
| | | | clause 8.2.15.2.1 |
| >> portDS.portState | R | R | IEEE Std 1588 [126] |
| | | | clause 8.2.15.3.1 |
| >> portDS.logMinDelayReqInterval | RW | RW | IEEE Std 1588 [126] |
| | | | clause 8.2.15.3.2 |
| >> portDS.logAnnounceInterval | RW | RW | IEEE Std 1588 [126] |
| | | | clause 8.2.15.4.1 |
| >> portDS.announceReceiptTimeout | RW | RW | IEEE Std 1588 [126] |
| | | | clause 8.2.15.4.2 |
| >> portDS.logSyncInterval | RW | RW | IEEE Std 1588 [126] |
| | | | clause 8.2.15.4.3 |
| >> portDS.delayMechanism | RW | RW | IEEE Std 1588 [126] |
| | | | clause 8.2.15.4.4 |
| >> portDS.logMinPdelayReqInterval | RW | RW | IEEE Std 1588 [126] |
| | | | clause 8.2.15.4.5 |
| >> portDS.versionNumber | RW | RW | IEEE Std 1588 [126] |
| | | | clause 8.2.15.4.6 |
| >> portDS.minorVersionNumber | RW | RW | IEEE Std 1588 [126] |
| | | | clause 8.2.15.4.7 |
| >> portDS.delayAsymmetry | RW | RW | IEEE Std 1588 [126] |
| | | | clause 8.2.15.4.8 |
| >> portDS.portEnable | RW | RW | IEEE Std 1588 [126] |
| | | | clause 8.2.15.5.1 |
| >> externalPortConfigurationPortDS.desiredState | RW | RW | IEEE Std 1588 [126] |
| | | | clause 15.5.3.7.15.1 |
| IEEE Std 802.1AS [104] data sets (NOTE 15) | | | |
| >> portDS.portIdentity | RW | RW | IEEE Std 802.1AS [104] |
| | | | clause 14.8.2 |
| >> portDS.portState | R | R | IEEE Std 802.1AS [104] |
| | | | clause 14.8.3 |
| >> portDS.ptpPortEnabled | RW | RW | IEEE Std 802.1AS [104] |
| | | | clause 14.8.4 |
| >> portDS.delayMechanism | RW | RW | IEEE Std 802.1AS [104] |
| | | | clause 14.8.5 |
| >> portDS.isMeasuringDelay | R | R | IEEE Std 802.1AS [104] |
| | | | clause 14.8.6 |
| >> portDS.asCapable | R | R | IEEE Std 802.1AS [104] |
| | | | clause 14.8.7 |
| >> portDS.meanLinkDelay | R | R | IEEE Std 802.1AS [104] |
| | | | clause 14.8.8 |
| >> portDS.meanLinkDelayThresh | RW | RW | IEEE Std 802.1AS [104] |
| | | | clause 14.8.9 |
| >> portDS.delayAsymmetry | RW | RW | IEEE Std 802.1AS [104] |
| | | | clause 14.8.10 |
| >> portDS.neighborRateRatio | R | R | IEEE Std 802.1AS [104] |
| | | | clause 14.8.11 |
| >> portDS.initialLogAnnounceInterval | RW | RW | IEEE Std 802.1AS [104] |
| | | | clause 14.8.12 |
| >> portDS.currentLogAnnounceInterval | R | R | IEEE Std 802.1AS [104] |
| | | | clause 14.8.13 |
| >> portDS.useMgtSettableLogAnnounceInterval | RW | RW | IEEE Std 802.1AS [104] |
| | | | clause 14.8.14 |
| >> portDS.mgtSettableLogAnnounceInterval | RW | RW | IEEE Std 802.1AS [104] |
| | | | clause 14.8.15 |
| >> portDS.announceReceiptTimeout | RW | RW | IEEE Std 802.1AS [104] |
| | | | clause 14.8.16 |
| >> portDS.initialLogSyncInterval | RW | RW | IEEE Std 802.1AS [104] |
| | | | clause 14.8.17 |
| >> portDS.currentLogSyncInterval | R | R | IEEE Std 802.1AS [104] |
| | | | clause 14.8.18 |
| >> portDS.useMgtSettableLogSyncInterval | RW | RW | IEEE Std 802.1AS [104] |
| | | | clause 14.8.19 |
| >> portDS.mgtSettableLogSyncInterval | RW | RW | IEEE Std 802.1AS [104] |
| | | | clause 14.8.20 |
| >> portDS.syncReceiptTimeout | RW | RW | IEEE Std 802.1AS [104] |
| | | | clause 14.8.21 |
| >> portDS.syncReceiptTimeoutTimeInterval | RW | RW | IEEE Std 802.1AS [104] |
| | | | clause 14.8.22 |
| >> portDS.initialLogPdelayReqInterval | RW | RW | IEEE Std 802.1AS [104] |
| | | | clause 14.8.23 |
| >> portDS.currentLogPdelayReqInterval | R | R | IEEE Std 802.1AS [104] |
| | | | clause 14.8.24 |
| >> portDS.useMgtSettableLogPdelayReqInterval | RW | RW | IEEE Std 802.1AS [104] |
| | | | clause 14.8.25 |
| >> portDS.mgtSettableLogPdelayReqInterval | RW | RW | IEEE Std 802.1AS [104] |
| | | | clause 14.8.26 |
| >> portDS.initialLogGptpCapableMessageInterval | RW | RW | IEEE Std 802.1AS [104] |
| | | | clause 14.8.27 |
| >> portDS.currentLogGptpCapableMessageInterval | R | R | IEEE Std 802.1AS [104] |
| | | | clause 14.8.28 |
| >> portDS.useMgtSettableLogGptpCapableMessageInterval | RW | RW | IEEE Std 802.1AS [104] |
| | | | clause 14.8.29 |
| >> portDS.mgtSettableLogGptpCapableMessageInterval | RW | RW | IEEE Std 802.1AS [104] |
| | | | clause 14.8.30 |
| >> portDS.initialComputeNeighborRateRatio | RW | RW | IEEE Std 802.1AS [104] |
| | | | clause 14.8.31 |
| >> portDS.currentComputeNeighborRateRatio | R | R | IEEE Std 802.1AS [104] |
| | | | clause 14.8.32 |
| >> portDS.useMgtSettableComputeNeighborRateRatio | RW | RW | IEEE Std 802.1AS [104] |
| | | | clause 14.8.33 |
| >> portDS.mgtSettableComputeNeighborRateRatio | RW | RW | IEEE Std 802.1AS [104] |
| | | | clause 14.8.34 |
| >> portDS.initialComputeMeanLinkDelay | RW | RW | IEEE Std 802.1AS [104] |
| | | | clause 14.8.35 |
| >> portDS.currentComputeMeanLinkDelay | R | R | IEEE Std 802.1AS [104] |
| | | | clause 14.8.36 |
| >> portDS.useMgtSettableComputeMeanLinkDelay | RW | RW | IEEE Std 802.1AS [104] |
| | | | clause 14.8.37 |
| >> portDS.mgtSettableComputeMeanLinkDelay | RW | RW | IEEE Std 802.1AS [104] |
| | | | clause 14.8.38 |
| >> portDS.allowedLostResponses | RW | RW | IEEE Std 802.1AS [104] |
| | | | clause 14.8.39 |
| >> portDS.allowedFaults | RW | RW | IEEE Std 802.1AS [104] |
| | | | clause 14.8.40 |
| >> portDS.gPtpCapableReceiptTimeout | RW | RW | IEEE Std 802.1AS [104] |
| | | | clause 14.8.41 |
| >> portDS.versionNumber | RW | RW | IEEE Std 802.1AS [104] |
| | | | clause 14.8.42 |
| >> portDS.nup | RW | RW | IEEE Std 802.1AS [104] |
| | | | clause 14.8.43 |
| >> portDS.ndown | RW | RW | IEEE Std 802.1AS [104] |
| | | | clause 14.8.44 |
| >> portDS.oneStepTxOper | R | R | IEEE Std 802.1AS [104] |
| | | | clause 14.8.45 |
| >> portDS.oneStepReceive | R | R | IEEE Std 802.1AS [104] |
| | | | clause 14.8.46 |
| >> portDS.oneStepTransmit | R | R | IEEE Std 802.1AS [104] |
| | | | clause 14.8.47 |
| >> portDS.initialOneStepTxOper | RW | RW | IEEE Std 802.1AS [104] |
| | | | clause 14.8.48 |
| >> portDS.currentOneStepTxOper | RW | RW | IEEE Std 802.1AS [104] |
| | | | clause 14.8.49 |
| >> portDS.useMgtSettableOneStepTxOper | RW | RW | IEEE Std 802.1AS [104] |
| | | | clause 14.8.50 |
| >> portDS.mgtSettableOneStepTxOper | RW | RW | IEEE Std 802.1AS [104] |
| | | | clause 14.8.51 |
| >> portDS.syncLocked | R | R | IEEE Std 802.1AS [104] |
| | | | clause 14.8.52 |
| >> portDS.pdelayTruncatedTimestampsArray | RW | RW | IEEE Std 802.1AS [104] |
| | | | clause 14.8.53 |
| >> portDS.minorVersionNumber | RW | RW | IEEE Std 802.1AS [104] |
| | | | clause 14.8.54 |
| >> externalPortConfigurationPortDS.desiredState | RW | RW | IEEE Std 802.1AS [104] |
| | | | clause 14.12.2 |

(NOTE 1):
R = Read only access; RW = Read/Write access; — = not supported.

In an example embodiment, a DetNet node management information container may comprise at least one of: an interface identifier e.g., IP port/interface, an identifier of a DetNet node (DetNet node ID), number of interfaces (or IP ports), IP prefix information, ethernet port information; MAC address information of ports, number of ethernet ports, and/or the like. In an example, embodiment, the number of interfaces may be the number of physical IP interfaces and the number of virtualized interfaces (for example, an Ethernet port may be virtualized to one or more IP interfaces).

In an example embodiment, the DetNet node management information container may comprise at least one of: IP address information and IP routing information.

In an example embodiment, the DetNet node management information container may comprise at least one of the user plane node management information container, the port management information container, and/or the like.

In an example embodiment, the user plane node and port management information container data models may be extended with IP address information and IP routing information.

In an example, the IP address information may comprise at least the following information for both IPv4 and IPv6:
IP address of the interface,
IP address/prefix length,
MTU size of an interface.

In an example, other IP configuration information about the IP interface may be included, such as the underlying Layer 2 interface type, properties and identifiers (e.g., MAC address) or the interface MTU size. The TSCTSF may read the underlying Layer 2 interface type, properties and identifiers (e.g., MAC address).

In an example, the TSCTSF may be configured to either configure or learn the IP address information of each DetNet Node interface.

In an example, the IP routing information may comprise at least an array of routing table entries with at least the following information for both IPv4 and IPv6:
IP address/prefix
address/prefix length
Next hop IP address

In an example, the DetNet flow assistance information container (or the DetNet flow assistance information) may comprise at least one of the DetNet flow IE, the DetNet service IE, and/or the like.

In an example, the network may send configuration parameters to the wireless device that may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example embodiment, a DetNet node configuration parameter may comprise at least one of: the DetNet node ID, network slice information (such as S-NSSAI, NSSAI, network slice instance identifier, and/or the like) associated with the DetNet (e.g., associated with the DetNet node, associated with one or more DetNet flows, and/or the like), a data network name (DNN) associated with the DetNet (e.g., associated with the DetNet node, associated with one or more DetNet flows, and/or the like), a UE route selection policy (URSP) associated with DetNet (e.g., associated with the DetNet node, associated with one or more DetNet flows, and/or the like), a user plane node ID, and/or the like.

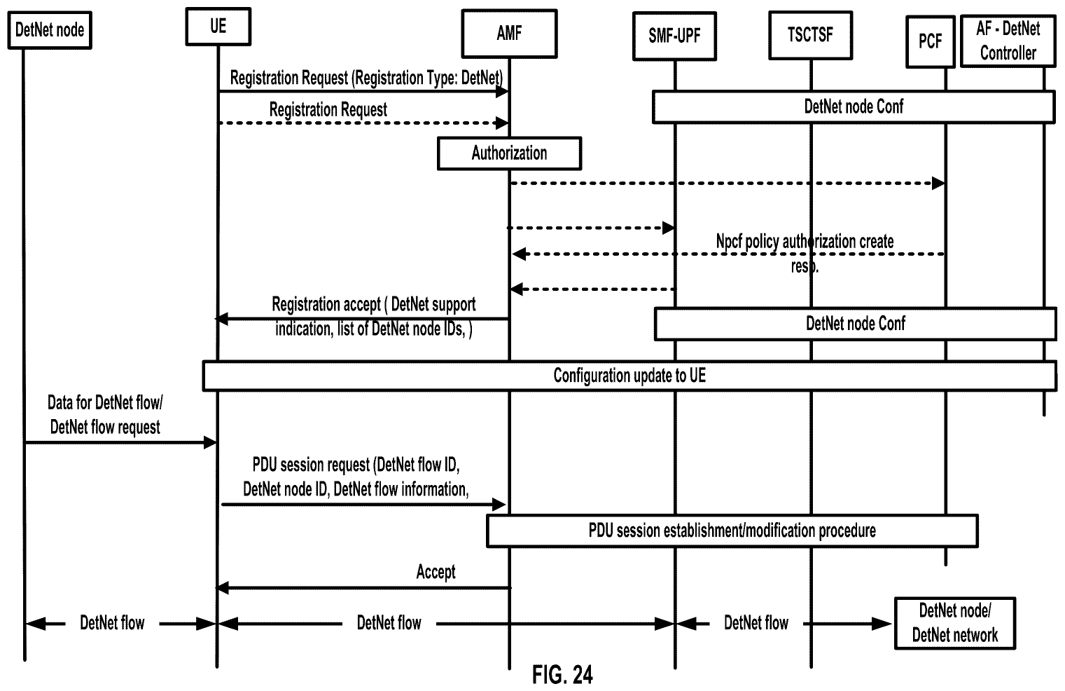

FIG. 24 illustrates an example registration procedure in a network in accordance with embodiments of the present disclosure. In an example, the network may be configured with a DetNet node as per example embodiments described in FIG. 21, FIG. 22, and FIG. 23. In an example embodiment, a wireless device (UE) may send to a base station (RAN node) a message. In an example, the message may be an access network (AN) message (e.g., may comprise AN parameters, registration request (that may comprise registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [Paging Subgrouping Support Indication], [UE Policy Container (the list of PSIs, indication of UE support for ANDSP and the operating system identifier)] and [UE Radio Capability ID], [Release Request indication], [Paging Restriction Information], PEI, [PLMN with Disaster Condition])).

In an example embodiment, the message (e.g., the AN message) or the registration request may comprise a registration type being DetNet. In an example, the registration type of DetNet may indicate that the UE may register with the network and act as a device side of a DetNet node (DetNet system). The UE may be configured with IP interfaces either on the UE or as part of a translator device or adapter. In an example, the UE may indicate registration type of DetNet when the UE comprises a device side translator (DS-T) for a DetNet node.

In an example embodiment, the message (e.g., the AN message) or the registration request may comprise a DetNet capability indication. The DetNet capability indication may indicate that the UE is capable of acting as a DS-T for the DetNet or is configured with interfaces. In an example, the interfaces may be configured on one or more ports of a translator adapter, the UE, and/or the like. In an example, the DetNet capability indicator may comprise one or more of: Indication of DetNet relay support; Indication of DetNet transit node support; Indication of DetNet edge node support, Support of protocols for DetNet configurations (e.g., NETCONF RFC6241, YANG RFC6020, PRE-CC RFC 8283, and/or the like.), and/or the like.

In an example, if a 5G-S-TMSI or GUAMI is not included or the 5G-S-TMSI or GUAMI does not indicate a valid AMF the (R)AN, based on RAT and Requested NSSAI, if available, selects an AMF. In an example, the RAN node may select an AMF based on the DetNet capability indictor, the registration type indicating DetNet, and/or the like. In an example, the RAN node may forward the registration request message to the AMF based on the N2 connection of the UE.

In an example, the (R)AN may send to the AMF an N2 message. In an example, the N2 message may comprise N2 parameters, registration request and [LTE-M Indication]. In an example, the N2 message may comprise the DetNet capability indicator. In an example, the N2 message may comprise the registration type of DetNet. When NG-RAN is used, the N2 parameters may comprise the Selected PLMN ID (or PLMN ID and NID, and/or the like), Location Information and Cell Identity related to the cell in which the UE is camping, UE Context Request which indicates that a UE context including security information needs to be setup at the NG-RAN. In an example, the AMF may initiate UE authentication by invoking an AUSF. In that case, the AMF may select an AUSF based on SUPI or SUCI.

In an example, the AMF may perform an AM Policy Association establishment/Modification procedure. If the AMF notifies the Mobility Restrictions (e.g. UE location) to the PCF for adjustment, or if the PCF updates the Mobility Restrictions itself due to some conditions (e.g. application in use, time and date), the PCF may provide the updated Mobility Restrictions to the AMF. If the subscription information may comprise Tracing Requirements, the AMF provides the PCF with Tracing Requirements. If the AMF supports DNN replacement, the AMF provides the PCF with the Allowed NSSAI and, if available, the Mapping Of Allowed NSSAI. If the PCF supports DNN replacement, the PCF provides the AMF with triggers for DNN replacement.

In an example, the AMF may send to a SMF a message. In an example, the message may be a Nsmf_PDUSession_UpdateSMContext ( ).

In an example, the AMF may send to the UE a NAS message, a message, and/or the like. In an example the NAS message or the message may be a registration accept message. The registration accept message may comprise one or more parameters (e.g., comprising: 5G-GUTI, Registration Area, [Mobility restrictions], [PDU Session status], [Allowed NSSAI], [Mapping Of Allowed NSSAI], [Configured NSSAI for the Serving PLMN], [Mapping Of Configured NSSAI], [NSSRG Information], [NSAG Information], [rejected S-NSSAIs], [Pending NSSAI], [Mapping Of Pending NSSAI], [Periodic Registration Update timer], [Active Time], [Strictly Periodic Registration Timer Indication], [LADN Information], [accepted MICO mode], [IMS Voice over PS session supported Indication], [Emergency Service Support indicator], [Accepted DRX parameters for E-UTRA and NR], [Accepted DRX parameters for NB-IoT], [extended idle mode DRX parameters], [Paging Time Window], [Network support of Interworking without N26], [Access Stratum Connection Establishment NSSAI Inclusion Mode], [Network Slicing Subscription Change Indication], [Operator-defined access category definitions], [List of equivalent PLMNs], [Enhanced Coverage Restricted information], [Supported Network Behaviour], [Service Gap Time], [PLMN-assigned UE Radio Capability ID], [PLMN-assigned UE Radio Capability ID deletion], [WUS Assistance Information], [AMF PEIPS Assistance Information], [Truncated 5G-S-TMSI Configuration], [Connection Release Supported], [Paging Cause Indication for Voice Service Supported], [Paging Restriction Supported], [Reject Paging Request Supported], [Paging Restriction Information acceptance/rejection], [“List of PLMN(s) to be used in Disaster Condition”], [Disaster Roaming wait range information], [Disaster Return wait range information]).

In an example embodiment, the registration accept message may comprise at least one of: a DetNet support indication, a DetNet capability indication, and/or the like. In an example, the DetNet support indication may indicate that the network supports one or more DetNet nodes, the network is part of a DetNet system, an element of the network is configured for DetNet, and/or the like.

In an example embodiment, the registration accept message may comprise at least one of: an identifier of a DetNet node, a list of DetNet nodes that are supported by the network, and/or the like. In an example embodiment, the registration accept message may comprise at least one of: the DetNet node management information container, the DetNet flow assistance information, and/or the like. In an example, the registration accept message (or a DL NAS message sent to the UE, or an RRC message from RAN node to the UE) may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example embodiment, the network may be configured for a DetNet node as described in example embodiments of the present disclosure. In an example, upon configuration of the DetNet node, the UE may be configured by the network to receive configuration parameters (that may comprise at least one of the DetNet node configuration parameter, the DetNet node management information container, and/or the like), to get updated on the parameters, and/or the like. In an example, the UE may receive the URSP, configuration update command, and/or the like via a procedure such as UE configuration update (UCU) procedure, network triggered DL NAS, and/or the like. In an example, the UE may employ the configuration information of DetNet to handle requests received from DetNet nodes e.g., for transmission of data packets associated with a DetNet flow, to establish a connection via the DetNet node for the DetNet flow, and/or the like. In an example, the UE may send a NAS message to the network (e.g., to the AMF or SMF via the RAN node). In an example the UE may send a PDU session establishment request, a PDU session modification request and/or the like. In an example, the NAS message may comprise the PDU session establishment request, the PDU session modification request and/or the like. In an example, the NAS message may comprise the DetNet node ID, the DetNet flow ID, and/or the like. In an example, the NAS message may comprise the DetNet flow assistance information container. In an example, the NAS message may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example, the network may allocate resources for the DetNet flow or the DetNet service and may send an acceptance message to the UE. In an example, the data packets for the DetNet flow may be transmitted via the DetNet node towards a DetNet node or a DetNet network.

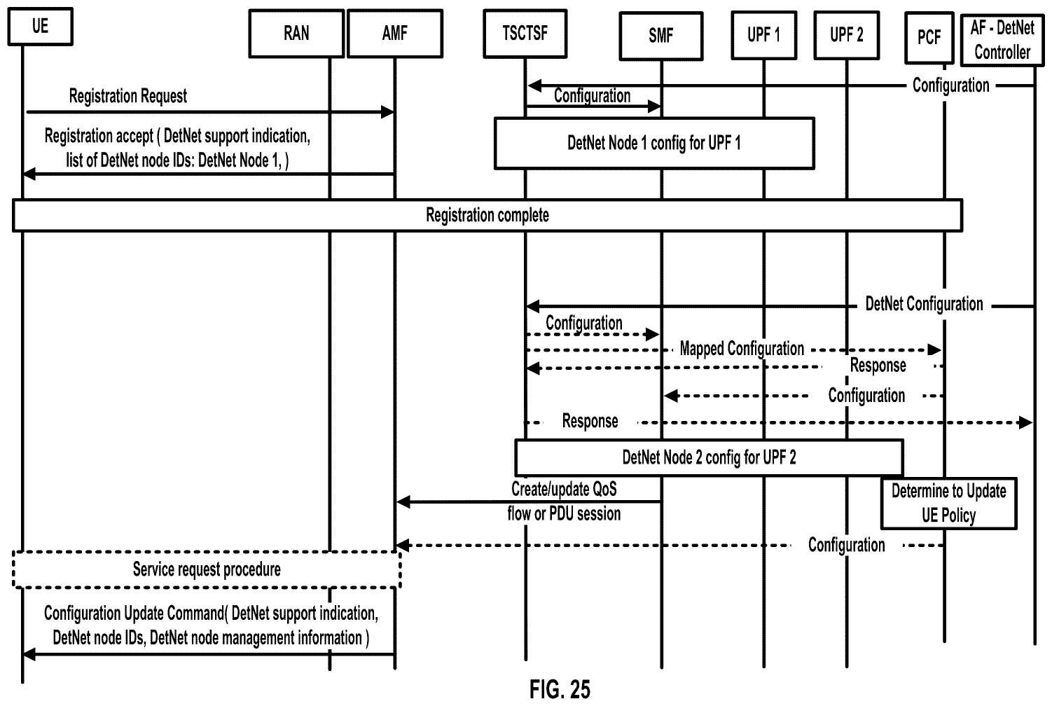

FIG. 25 illustrates an example configuration procedure in a network in accordance with embodiments of the present disclosure. In an example, a DetNet controller may configure a network as per an example embodiment of the present disclosure. In an example, the network may be configured with DetNet node 1. In an example, the UE may register with the network. In an example, the DetNet controller may configure the network with DetNet node 2.

In an example embodiment, the DetNet controller may configure the network as follows. The DetNet controller may provides configuration (e.g., YANG or other format) to the TSCTSF. The TSCTSF may employ the identity of the incoming and outgoing interfaces to determine the affected PDU Session(s) and whether the flow is uplink or downlink. The TSCTSF may determine if the flow is UE to UE in which case two PDU Sessions may be affected for the flow and can also verify whether the specified routing is applicable. The TSCTSF may map the configuration as described above and calculates the delay and PER requirements and the TSC Assistance Container for each flow description. The TSCTSF may provide the mapped parameters and the flow description to the PCF on PDU Session basis. In an example, the PCF may determine, based on the parameters received from the TSCTSF, whether the existing QoS flows need to be modified or a new QoS flow needs to be created. In an example, a DetNet Assistance Container, a DetNet node management container, a DetNet flow assistance information, and/or the like may be provided to the SMF. In an example, a TSC Assistance Container may be provided to the SMF. In an example, the PCF may respond to the TSCTSF, which may comprise information about the success of the configuration. In an example, the TSCTSF may provide a response to the DetNet controller regarding the success of the configuration setup.

In an example embodiment as depicted in FIG. 25, the PCF may determine/decide to update UE policy based on triggering conditions such as registration of UE with a DetNet capability indication, registration with registration type DetNet, an initial registration, registration with 5GS when the UE moves from EPS to 5GS, or need for updating UE policy as follows: for the case of initial registration and registration with 5GS when the UE moves from EPS to 5GS, the PCF compares the list of PSIs included in the UE policy information in Npcf_UEPolicyControl_Create request and determines, whether UE policy information have to be updated and be provided to the UE via the AMF using DL NAS TRANSPORT message; for the network triggered UE policy update case (e.g., the change of UE location, the change of Subscribed S-NSSAIs), the PCF checks the latest list of PSIs to decide which UE policies have to be sent to the UE.

In an example, the PCF may update UE policy or send configuration parameters to the UE in response to receiving DetNet configuration parameters, DetNet flow request, and/or the like, from the TSCTSF, the DetNet controller, the NEF, and/or the like.

In an example, the PCF may check if the size of the resulting UE policy information exceeds a predefined limit:
If the size is under the limit, then UE policy information are included in a single Namf_Communication_N1N2MessageTransfer service operation as described below.
If the size exceeds the predefined limit, the PCF splits the UE policy information in smaller, logically independent UE policy information ensuring the size of each is under the predefined limit. Each UE policy information will be then sent in separated Namf_Communication_N1N2MessageTransfer service operations as described below.

In an example, if the PCF has not subscribed to be notified by the AMF about the UE response to an update of UE policy information, the PCF subscribes to the AMF to be notified about the UE response to an update of UE policy information.

In an example, the PCF may send a message to the AMF e.g., the PCF may send/invoke Namf_Communication_N1N2MessageTransfer service operation provided by the AMF. The message may comprise SUPI, UE policy container. In an example, the message (sent by the PCF to the AMF) may comprise the DetNet support indication, DetNet capability indication, the identifier of the DetNet node, and/or the like. In an example, the message (sent by the PCF to the AMF) may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like. In an example, the UE policy container may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like. In an example, the AMF may transmit at least an element of the message (e.g., the message sent by the PCF to the AMF) to the UE via a NAS message.

In an example, if the UE is registered and reachable by AMF in either 3GPP access or non-3GPP access, the AMF may transfer transparently the UE Policy container to the UE via the registered and reachable access. In an example, if the UE is registered in both 3GPP and non-3GPP accesses and reachable on both access and served by the same AMF, the AMF may transfer transparently the UE Policy container to the UE via one of the accesses based on the AMF local policy. In an example, if the UE is not reachable by AMF over both 3GPP access and non-3GPP access, the AMF may report to the PCF that the UE Policy container could not be delivered to the UE using Namf_Communication_N1N2TransferFailureNotification. In an example, if the AMF determines/decides to transfer transparently the UE Policy container to the UE via 3GPP access, e.g., the UE is registered and reachable by AMF in 3GPP access only, or if the UE is registered and reachable by AMF in both 3GPP and non-3GPP accesses served by the same AMF and the AMF decides to transfer transparently the UE Policy container to the UE via 3GPP access based on local policy and the UE is in CM-IDLE and reachable by AMF in 3GPP access, the AMF starts the paging procedure by sending a Paging message and perform a network triggered service request procedure. Upon reception of paging request, the UE may initiate the UE Triggered Service Request procedure. In an example, if the UE is in CM-CONNECTED over 3GPP access or non-3GPP access, the AMF transfers transparently the UE Policy container (UE policy information) received from the PCF to the UE. The UE Policy container may comprise the list of Policy Sections or policy parameters. In an example, the policy parameters may be a UE route selection policy (URSP). In an example, the UE may update the UE policy provided by the PCF and may send the result to the AMF. The AMF may forward the response of the UE to the PCF using Namf_Communication_N1MessageNotify.

The PCF maintains the latest list of PSIs delivered to the UE and updates the latest list of PSIs in the UDR by invoking Nudr_DM_Update (SUPI, Policy Data, Policy Set Entry, updated PSI data) service operation.

If the PCF is notified about UE Policy delivery failure from the AMF, the PCF may initiate UE Policy Association Modification procedure to provide a new trigger “Connectivity state changes” in Policy Control Request Trigger of UE Policy Association to AMF as defined in clause 4.16.12.2. The PCF may re-initiate the UE Configuration Update procedure for transparent UE Policy delivery as in step 1 when the PCF is notified of the UE connectivity state changed to CONNECTED.

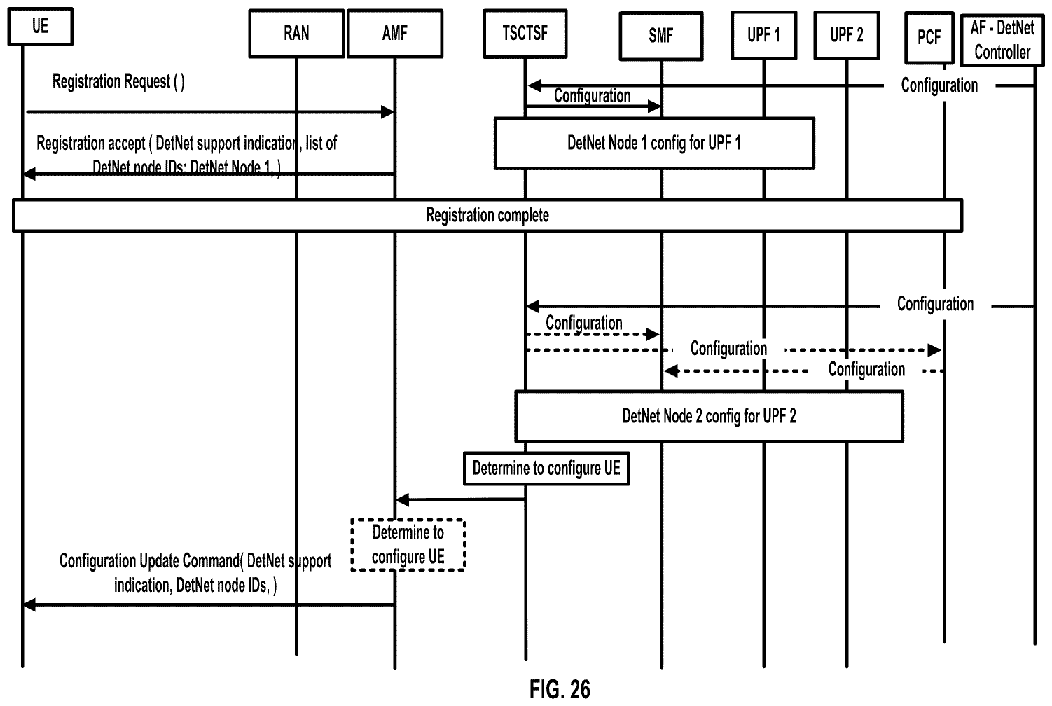

FIG. 26 illustrates an example configuration procedure initiated by the TSCTSF or the AMF in a network in accordance with embodiments of the present disclosure. In an example, the network may be configured with DetNet node 1. In an example, the UE may register with the network. In an example, the DetNet controller may configure the network with DetNet node 2. In an example, the TSCTSF may determine to configure the network for the DetNet (e.g., a DetNet flow, a DetNet node, and/or the like). In an example, the TSCTSF may receive a message from the DetNet controller. The message may be received via the NEF. In an example, the message may be a configuration message, a configuration request, configuration update, DetNet flow resource request, DetNet node resource request, an Ntsctsf QoS and Assistance info create request message (e.g., comprising the DetNet node ID, DetNet Flow ID, DetNet Flow requirements, and/or the like). In an example, the message (e.g., the configuration message received from the TSCTSF) may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example, the TSCTSF may determine to configure one or more wireless devices to act as the DetNet device side of the DetNet node. In an example, the TSCTSF may send a configuration message to the AMF. In an example, the AMF may determine one or more wireless devices that are registered with either DetNet capability, or registration type DetNet. In an example, the AMF may send a configuration update command to the or more wireless devices based on the determining. In an example, the configuration update command may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like. In an example, the configuration update command may comprise the URSP for the DetNet.

In an example, the AMF may determine the necessity of UE configuration change due to various reasons (e.g., receiving a trigger from the TSCTSF, receiving the configuration message from the TSCTSF (that may comprise parameters of the DetNet node, DetNet configuration parameters, and/or the like), UE mobility change, NW policy, reception of Subscriber Data Update Notification from UDM, change of Network Slice configuration (including due to change of the NSSRG information in subscription information, or due to change of NSAG Information), need to assign PLMN-assigned UE Radio Capability ID, change of Enhanced Coverage Restriction information in the UE context) or that the UE needs to perform a Registration Procedure. If a UE is in CM-IDLE, the AMF may wait until the UE is in CM-CONNECTED state or triggers Network Triggered Service Request.

In an example embodiment, the AMF may include Mobility Restriction List in N2 message that delivers UE Configuration Update Command to the UE if the service area restriction for the UE is updated.

In an example embodiment, the AMF may send a message to the UE. In an example, the message may be a UE configuration update command that may comprise one or more UE parameters (e.g., comprising: the DetNet support indication, the DetNet capability indication, an identifier of the DetNet node, a S-NSSAI associated with the DetNet node, a DNN associated with the DetNet node, configuration update indication, 5G-GUTI, TAI List, Allowed NSSAI, Mapping Of Allowed NSSAI, Configured NSSAI for the Serving PLMN, Mapping Of Configured NSSAI, [NSSRG Information], rejected S-NSSAIs, NITZ, Mobility Restrictions, LADN Information, MICO, Operator-defined access category definitions, SMS Subscribed Indication, [PLMN-assigned UE Radio Capability ID], [PLMN-assigned UE Radio Capability ID deletion indication], [“List of PLMN(s) to be used in Disaster Condition”], [Disaster Roaming wait range information], [Disaster Return wait range information], [MPS priority]) to the UE. In an example, the AMF may update the rejected S-NSSAIs in the UE Configuration Update command. In an example, the UE configuration update command may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example embodiment, the AMF may include one or more of the DetNet support indication, the DetNet capability indication, an identifier of the DetNet node, a S-NSSAI associated with the DetNet node, a DNN associated with the DetNet node, 5G-GUTI, TAI List, Allowed NSSAI, Mapping Of Allowed NSSAI, Configured NSSAI for the Serving PLMN, Mapping Of Configured NSSAI, rejected S-NSSAIs, NITZ (Network Identity and Time Zone), Mobility Restrictions parameters, LADN Information, Operator-defined access category definitions, PLMN-assigned UE Radio Capability ID, or SMS Subscribed Indication if the AMF wants to update these NAS parameters without triggering a UE Registration procedure.

In an example embodiment, the AMF may include in the UE configuration update command configuration update indication parameters indicating whether:
Network Slicing Subscription Change has occurred;
the UE shall acknowledge the command; and
whether a Registration procedure is requested.

In an example embodiment, if the AMF indicates Network Slicing Subscription Change, then the UE may locally erase all the network slicing configuration for all PLMNs and, if applicable, update the configuration for the current PLMN based on any received information. If the AMF indicates Network Slicing Subscription Change, the UE may also be requested to acknowledge.

In an example embodiment, if the AMF also includes in the UE Configuration Update Command message a new Configured NSSAI for the Serving PLMN, then the AMF may include a new Allowed NSSAI with, if available, the associated Mapping Of Allowed NSSAI, unless the AMF cannot determine the new Allowed NSSAI after the Subscribed S-NSSAI(s) are updated, in which case the AMF does not include in the UE Configuration Update Command message any Allowed NSSAI. If the UE has indicated its support of the subscription-based restrictions to simultaneous registration of network slices feature in the UE 5GMM Core Network Capability, the AMF includes, if available, the NSSRG Information. If the UE has not indicated its support of the subscription-based restrictions to simultaneous registration of network slices feature and the subscription information for the UE includes NSSRG information and the AMF is providing the Configured NSSAI to the UE, the Configured NSSAI may include the S-NSSAIs.

In an example embodiment, if the UE configuration update indication requires acknowledgement of the UE configuration update command, then the UE may send a UE configuration update complete message to the AMF. The AMF may request acknowledgement for all UE configuration updates, except when only NITZ is provided.

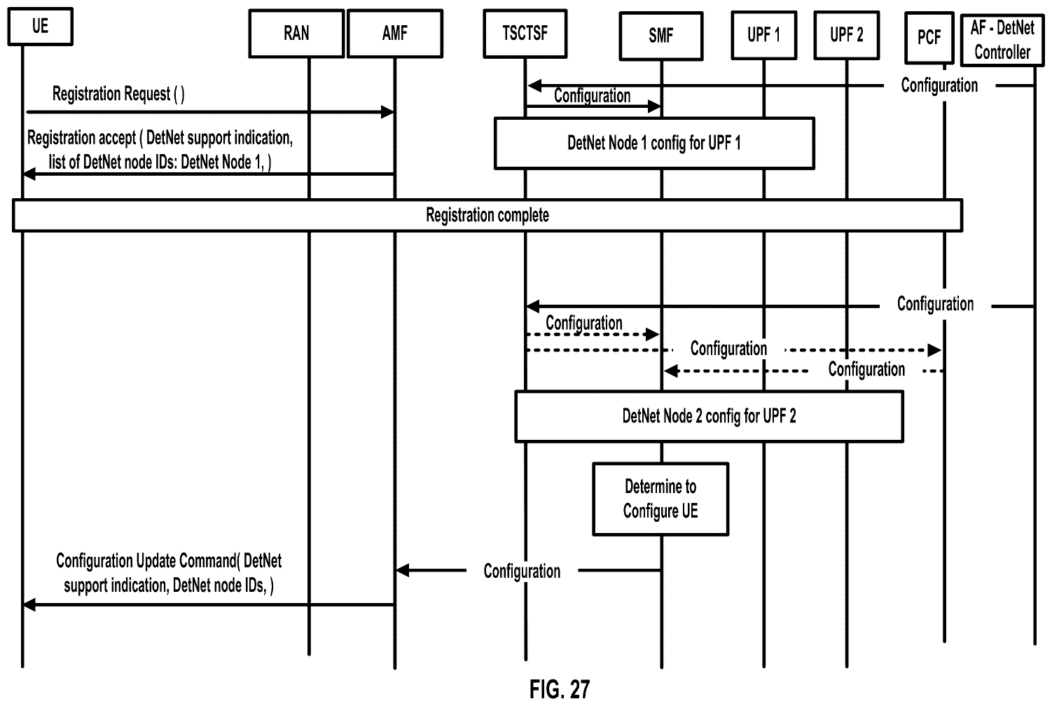

FIG. 27 illustrates an example configuration procedure in a network in accordance with embodiments of the present disclosure. In an example, the network may be configured with DetNet node 1. In an example, the UE may register with the network. In an example, the DetNet controller may configure the network with DetNet node 2. In an example, the SMF may receive DetNet configuration parameters, DetNet flow parameters, and/or the like from the PCF, TSCTSF, the DetNet controller, and/or the like. In an example, the SMF may trigger configuration of the UE via NAS messages. In an example, the NAS message may be SM-NAS message. In an example, the NAS message may be a configuration update message sent to the UE via the AMF and the RAN node. In an example, the NAS message may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example, the SMF may request modification of a PDU session of the UE. In an example, the SMF may send/invoke a message (to the AMF) such as Namf_Communication_N1N2MessageTransfer ([N2 SM information] (PDU Session ID, QFI(s), QoS Profile(s), [Alternative QoS Profile(s)], Session-AMBR, [CN Tunnel Info(s)], QoS Monitoring indication, QoS Monitoring reporting frequency, [TSCAI(s)]), N1 SM container (PDU Session Modification Command (PDU Session ID, QoS rule(s), QoS Flow level QoS parameters if needed for the QoS Flow(s) associated with the QoS rule(s), QoS rule operation and QoS Flow level QoS parameters operation, Session-AMBR))). In an example the message may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example, the message may comprise a protocol configuration option (PCO) or enhanced PCO (ePCO). In an example, the PCO or the ePCO may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example, the N2 SM information may comprise the PCO or the ePCO. In an example, the message may be a PDU session modification command. In an example, the N2 SM information may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example, the SMF may indicate for each QoS Flow whether redundant transmission may be performed by a corresponding redundant transmission indicator. If the SMF decides to activate redundant transmission, the SMF may include the allocated additional CN Tunnel Info in the N2 SM information. If the SMF decides to perform redundant transmission for new QoS Flow with two I-UPFs, the SMF includes the allocated CN Tunnel Info of the two I-UPFs in the N2 SM information. If redundant transmission has been activated on the PDU Session and the SMF decides to stop redundant transmission, the SMF indicates the (R)AN to release the AN Tunnel and stop packet duplication and elimination associated with the redundancy tunnel of the PDU Session.

In an example embodiment, the AMF may send a message to the RAN node. In an example, the message may be an N2 message. In an example, the N2 message may comprise [the N2 SM information received from SMF], NAS message (PDU Session ID, N1 SM container (PDU Session Modification Command), and/or the like.

In an example, the N2 message (or an element of the N2 message) may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example embodiment, the (R)AN may send/issue AN specific signalling exchange with the UE that is related with the information received from SMF. For example, in the case of a NG-RAN, an RRC Connection Reconfiguration may take place with the UE modifying the necessary (R)AN resources related to the PDU Session or if N1 SM container is received from the AMF, RAN transports the N1 SM container to the UE.

In an example, the (R)AN may consider the updated CN assisted RAN parameters tuning to reconfigure the AS parameters. In an example, the N1 SM container may be provided to the UE. If the N1 SM container includes a Port Management Information Container then the UE provides the container to DS-TT. In an example, if the N1 SM container comprises DetNet node management information container, the UE may provide the container to the DS-T (e.g. the DetNet translator).

If DetNet node configuration parameter is provided to the UE in the PCO, the UE may refresh all configuration information bound to the PDU Session associated with the DetNet. If new DNS server address is provided to the UE in the PCO, the UE can refresh all EAS(s) information (e.g. DNS cache) bound to the PDU Session.

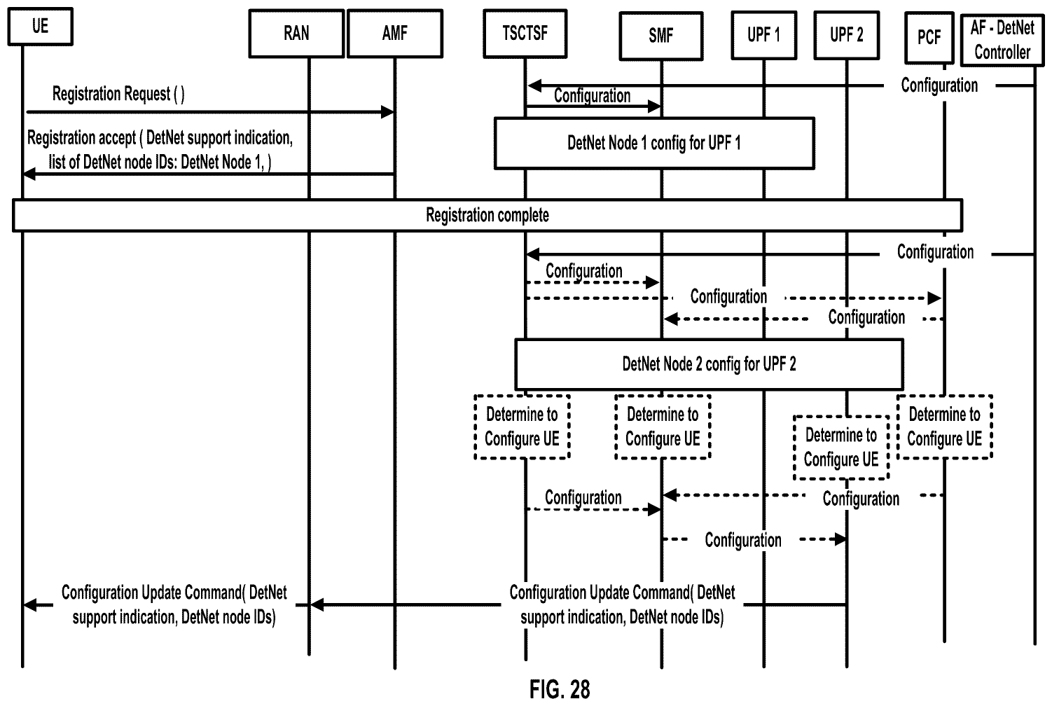

FIG. 28 illustrates an example of a configuration procedure in accordance with embodiments of the present disclosure. In an example, the network may configure the UE via user plane. In an example, upon configuration of a network for DetNet as described in example embodiments, the network may send configuration information to one or more UEs. In an example, the one or more UEs may have a PDU session established with a UPF associated with the DetNet node. In an example, the configuration may comprise at least one of: the DetNet node management information container, the DetNet node configuration parameter, the DetNet flow assistance information container, the identifier of the DetNet node (DetNet node ID), the identifier of the DetNet flow (DetNet flow ID), the identifier of the DetNet service, and/or the like.

In an example embodiment, the configuration information may be sent via PDU session of the UE with the UPF. In an example, the UPF may send a message to the UE. In an example, the message may comprise the configuration information. In an example, the message may comprise application layer information that may comprise the configuration information. In an example, the message may comprise an address or identifier of a translator device such as the DS-T or device side DetNet translator (DS-DT). In an example, the UE may determine based on the identifier of the DS-T or DS-DT that the message is for configuration of the UE to act as the device side of the DetNet node.

In an example embodiment, the configuration information may comprise the DetNet node ID, the DetNet node management information container, and/or the like.

In an example embodiment, the network may determine to release or deactivate a PDU session of a UE with a UPF associated with the DetNet. In an example, the SMF may receive a message from the UPF that is assigned a node ID for DetNet node (e.g., DetNet ID, DetNet node ID, and/or the like). In an example, the SMF may determine that the UE is not registered for DetNet node, e.g., the UE does not have the DetNet capability, the registration type is not DetNet, the PDU session request message sent from the UE to the SMF does not comprise the DetNet capability indication, and/or the like. In an example, the SMF based on the determining may release a PDU session of the UE that is terminated by the UPF of the DetNet node. In an example, the SMF may send a NAS message to the UE (via the AMF and the RAN node) to release the PDU session.

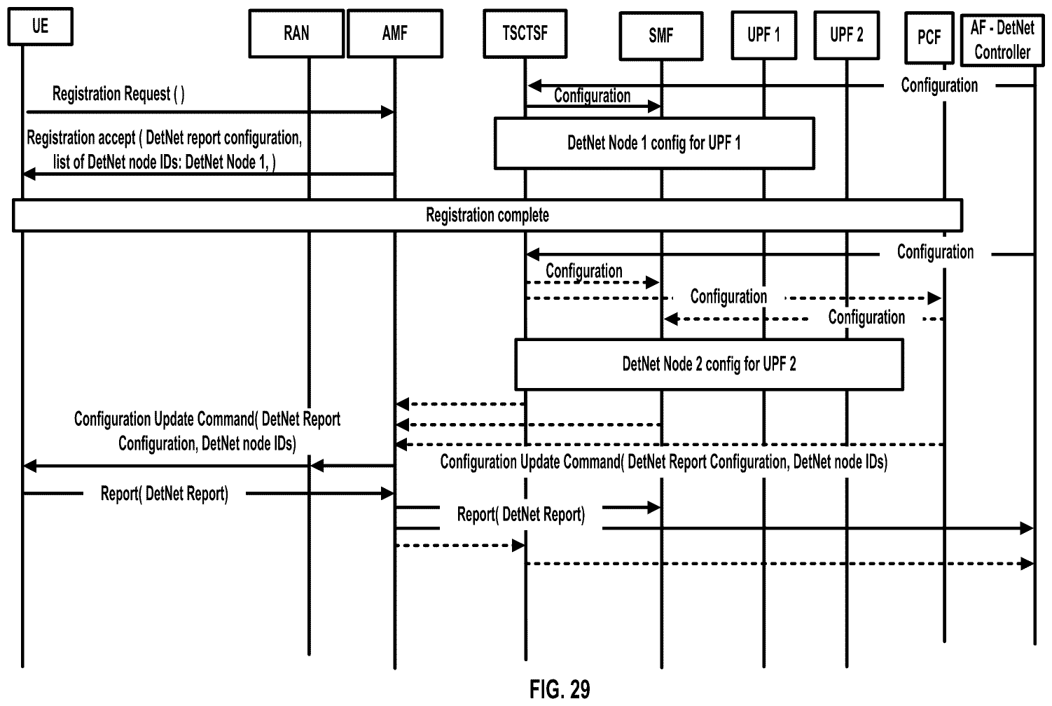

FIG. 29 illustrates an example of a configuration procedure for report of events in accordance with embodiments of the present disclosure. In an example, the wireless device may report status of DetNet resources, status of DetNet service, status of DetNet flow, and/or the like. In an example, the status may be related to status of an adjacent or neighboring DetNet node.

In an example embodiment, the wireless device may receive from the network a message e.g., a NAS message, the configuration update command, and/or the like. In an example, the message may be employed to configure the wireless device for reporting a status of DetNet resources, the DetNet node, the DetNet flow, the DetNet service, and/or the like. In an example, the message may comprise: DetNet reporting configuration information, a list of reporting events, a threshold value for triggering a status report (e.g., a DetNet report), and/or the like.

In an example, the wireless device may send to the network a report message e.g., a NAS message comprising the DetNet report. In an example, the wireless device may send the NAS message to the AMF. In an example, the AMF may send the NAS message that contains the DetNet report to the SMF. In an example, the AMF may send the DetNet report to the TSCTSF. In an example, the AMF may send the DetNet report to the PCF. In an example, the DetNet controller, e.g., the AF may receive the DetNet report via the NEF. In an example the AF or DetNet controller may receive the DetNet report from the SMF, the AMF, the TSCTSF, and/or the like.

In an example, the DetNet report may comprise at least one of: a report (e.g., the report as described in example embodiments), the DetNet node ID, the status of DetNet resources, and/or the like.

In an example, the status of DetNet resources may comprise at least one of a status of buffer (utilization), number of buffers available, a status of a DetNet flow, a status of a DetNet service, a status of DetNet ingress, a status of DetNet egress, and/or the like.

In an example, the list of reporting events may comprise at least one of a status of buffer (utilization), number of buffers available, a status of a DetNet flow, a status of a DetNet service, a status of DetNet ingress, a status of DetNet egress, and/or the like. In an example, the first request message may comprise at least one of a condition for reporting the status of DetNet resources

In an example, the report may comprise at least one of the DetNet flow status, the status of DetNet service, and/or the like.

In an example embodiment, the report may comprise an event. In an example, the event may be at least one of: a DetNet flow failure, a DetNet service failure, a DetNet node failure, a DetNet resource status update, a status of a DetNet resource, and/or the like.

In an example embodiment, the report may comprise at least one of the list of DetNet reporting events that may be related to DetNet flow (e.g., DnFlowStatus), the DetNet service (e.g., DnServiceStatus), the DetNet node availability (status) and/or the like. In an example, the report may comprise at least one of an identifier of the DetNet flow associated with the report, an identifier of the DetNet service associated with the report an identifier of the DetNet node associated with the report, and/or the like.

In an example, the DetNet reporting configuration information may comprise at least one of a threshold for reporting a status or reporting an event. In an example, the DetNet reporting configuration information may comprise at least one of a condition for reporting a status or reporting an event. For example, the threshold or condition may indicate that if the utilization or occupation of a resource exceed a certain value, a report may be provided. For example, the condition or threshold may indicate that buffer space or utilization of a buffer at a node (e.g., RAN, UPF, UE, and/or the like) exceeds % 70, % 50 or another value, a report may be performed by the node. For example, the condition or threshold may indicate that if performance of a path is above/below a certain value or a within a range of values, a reporting may be performed. In an example, the performance may be delay, packet loss ratio, available bandwidth, jitter, and/or the like.

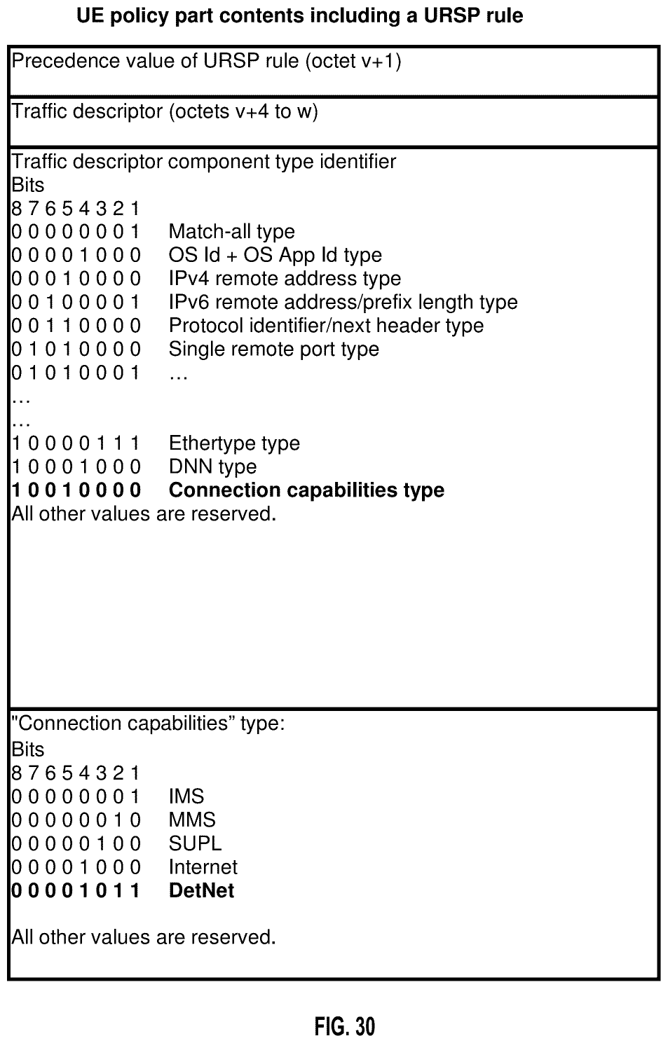

FIG. 30 illustrates an example of a configuration parameter or URSP (and example elements) in accordance with embodiments of the present disclosure. A URSP rule may comprise a traffic descriptor that determines when the rule is applicable. The URSP rule may be determined to be applicable when one or more components in the traffic descriptor matches the corresponding information from a request by the higher layer layers of the UE or an application.

The URSP rule may comprise a list of route selection descriptors comprising one or multiple route selection descriptors having a different route selection descriptor precedence value. A route selection descriptor may comprise one or more of the following components: session and service continuity (SSC) mode that Indicates that the traffic of the matching application may be routed via a PDU Session supporting the included SSC Mode; network slice selection indicating that the traffic of the matching application may be routed via a PDU Session supporting one or more of the included S-NSSAIs; DNN selection indicating that the traffic of the matching application may be routed via a PDU session supporting any of the included DNNs. When DNN is used in traffic descriptor, corresponding route selection descriptor of the rule may or may not include DNN selection component; PDU session type selection indicating that the traffic of matching application may be routed via a PDU session supporting the included PDU session type; Non-Seamless offload indication may comprise indicating that traffic of the matching application is to be offloaded to non-3GPP access outside of a PDU Session when the rule is applied; access type preference may be employed if the UE needs to establish a PDU session when the rule is applied, this indicates the access type (3GPP or non-3GPP or multi-access) on which the PDU Session should be established. The type “Multi-Access” may indicate that the PDU Session should be established as a MA PDU session, using both 3GPP access and non-3GPP access.

In an example, as depicted in FIG. 30, the URSP may comprise a traffic descriptor and a traffic descriptor component type identifier. The traffic descriptor component type identifier may comprise a connection capabilities type. The connection capabilities type may be DetNet, TSN, TSC, IMS, MMS, SUPL, MPS or MPS for DTS. In an example, the UE may determine to use the URSP rule associated with the DetNet connection capabilities type. The rule or policy associated with the DetNet connection capabilities may comprise a DNN associated with the DetNet node, a S-NSSAI associated with the DetNet node, PDU session type(s) associated with the DetNet node, and or the like. For example, when the UE determines to send a PDU session establishment request message to the network for a PDU session that is for transmission of a DetNet flow, the UE may send a NAS message (PDU session establishment request message) comprising an identifier of the DetNet flow, the DNN and/or the S-NSSAI(s) associated with connection capabilities type identifier of DetNet.

In an example, when the network supports one or more DetNet nodes, the URSP rules may be per DetNet node. For example, DetNet node 1 with DetNet node ID 1 may be associated with a first set of URSP rules or policies, and DetNet node 2 with DetNet node ID 2 may be associated with a second set of URSP rules or policies. In an example, the URSP rules may be per DetNet flow.

In an example embodiment, the wireless device may receive from a network node, a first non-access stratum (NAS) message. In an example, the first NAS may comprise parameters to configure the wireless device to operate as a device side of a DetNet node. In an example, the parameters may comprise an identifier of the DetNet node. In an example, wireless device may send to a session management function (SMF), a second NAS message to establish or modify a PDU session for a DetNet flow associated with the DetNet node.

In an example, the first NAS message may comprise at least one of: a DetNet flow assistance information container, an identifier of the DetNet node, an identifier of a network slice associated with the DetNet node, an indication that the network supports DetNet capability. In an example, the DetNet capability may comprise one or more of: an indication of DetNet relay support, an indication of DetNet transit node support, an indication of DetNet edge node support, support of protocols for DetNet configurations (e.g., NETCONF RFC6241, YANG RFC6020, PRE-CC RFC 8283, and/or the like.), and/or the like. In an example, the first NAS message may be a configuration update command message. In an example, the configuration update command message may be received from the AMF via the RAN node. In an example, the configuration update command message may be received from a Time Sensitive communication Time Synchronization function (TSCTSF) via a SMF or an AMF. In an example, the network node may be at least one of: a session management function (SMF), the TSCTSF, or the SMF. In an example, the second NAS message may comprise at least one of: an identifier of a PDU session associated with the DetNet flow, an identifier of the DetNet flow, an identifier of a network slice associated with the DetNet flow or the DetNet node, and/or the like. In an example, the wireless device may receive from the SMF, IP address information comprising at least one of the following: the IP address of an interface of the wireless device, the IP address/prefix length. In an example, the wireless device may receive data packets for a DetNet flow. In an example, the wireless device may route the data packets of the DetNet flow via the PDU session based on the IP address information. (e.g., to the UPF, towards a DetNet network, or to another DetNet node). In an example, the wireless device may send to the network, a request to establish a PDU session. In an example, the wireless device may receive from the network, an acceptance of the request. In an example, the parameters may comprise a reporting configuration for DetNet. In an example, the reporting configuration may comprise configuration parameters for reporting of: a status of a DetNet flow, a status of a DetNet service, a status of DetNet ingress, a status of DetNet egress, and/or the like. In an example, the parameters may comprise: a list of reporting events, a threshold value for triggering a status report (e.g., the DetNet report). In an example, the parameters may comprise a user equipment route selection policy (URSP) (e.g., being at least one route configuration rule). In an example, the URSP may comprise: a traffic descriptor of the DetNet system/node may comprise an identifier of a DetNet node, an identifier of a traffic descriptor of the DetNet node, a priority value of the traffic descriptor of the DetNet node, a DetNet connection capability, and/or the like. In an example, the URSP may comprise at least one of: an identifier of the DetNet node, a single network slice selection assistance information (S-NSSAI) associated with the DetNet node, a data network name (DNN) associated with the DetNet node, a PDU session type associated with the DetNet node, an access type associated with the DetNet node, a radio access technology (RAT) type associated with the DetNet node, and/or the like. In an example, the first NAS message may be at least one of: a configuration update message. In an example, the first NAS message may comprise a protocol configuration option (PCO) information element or an enhanced PCO (ePCO). In an example, the first NAS message may be a registration accept message. In an example, the wireless device may receive a request for a DetNet flow. In an example, the request may comprise an identifier of the DetNet flow. In an example, the request may be received from: a DetNet end station/node, a device side translator device, a DetNet network, a network side translator device, a node of a DetNet system, and/or the like.

In an example embodiment a wireless device may register to a network that acts as one or more DetNet nodes (e.g., one or more UPFs are allocated for the DetNet node). The wireless device may receive from a DetNet end node a request for a flow of a DetNet.

In an example embodiment, the wireless device may send to a network, a first message requesting access to the network. In an example, the wireless device may receive from the network, a deterministic network (DetNet) node configuration parameter that may comprise: an identifier of the DetNet node, an identifier of a network slice associated with the DetNet node, and/or the like. In an example, the wireless device may receive from a node, a request for a DetNet flow. In an example, the request may comprise: an identifier of the DetNet flow, the identifier of the DetNet node, and/or the like. In an example, the wireless device may determine to establish a packet data unit (PDU) session with the network for the DetNet flow. In an example, the wireless device may send to a session management function (SMF) of the network a second NAS message. In an example, the second NAS message may comprise the identifier of the DetNet flow, the identifier of the network slice associated with the DetNet node, and/or the like.

In an example embodiment, a wireless device may send to a network, a first message requesting access to the network. The wireless device may receive from the network, parameters to configure the wireless device to operate as a device side of a DetNet node. In an example, the parameters may comprise: an identifier of the DetNet node, an identifier of a network slice associated with the DetNet node, and/or the like. In an example, the wireless device may receive from a node, a request for a DetNet flow. In an example, the request may comprise an identifier of the DetNet flow. In an example, the wireless device may send to the SMF of the network a second NAS message comprising: the identifier of the DetNet flow, the identifier of the network slice associated with the DetNet node, and/or the like.

In an example, the wireless device may receive from the network, an indication that the network supports DetNet capability. In an example, the DetNet capability may comprise one or more of: Indication of DetNet relay support, Indication od DetNet transit node support, Indication of DetNet edge node support, support of protocols for DetNet configurations (e.g., NETCONF RFC6241, YANG RFC6020, PRE-CC RFC 8283, and/or the like.). In an example, the first message may comprise a registration type indicating that the registration is for DetNet. In an example, the first message may comprise a DetNet capability indicator. In an example, the second NAS message may be at least one of: a PDU session establishment request message, a PDU session modification request message, a service request message and/or the like. In an example, the second NAS message may comprise a PDU session type being DetNet. In an example, the DetNet node configuration parameter may comprises a data network name (DNN) associated with the DetNet. In an example, the wireless device may determine to establish a packet data unit (PDU) session with the network for the DetNet flow. In an example, the request may comprise the identifier of the DetNet node.

In an example embodiment, a wireless device may be registered and establish a PDU sessions with one or multiple UPFs. When a UPF is designated as a DetNet node, the network updates the UE. The network may configure a UE that is registered with the network to indicate all the UPFs that are part of DetNet system for example the configuration may comprise a list of DetNet node IDs that the network supports. (e.g., based on the assumption of per UPF granularity for DetNet).

In an example embodiment, the wireless device may receive from a network node, a first non-access stratum (NAS) message comprising a deterministic network (DetNet) node management information container. In an example, the wireless device may determine to modify a packet data unit (PDU) session with the network for a flow of the DetNet. In an example, the wireless device may send to the SMF of the network, a second NAS message comprising: an identifier of the DetNet flow, an identifier of a network slice associated with the DetNet flow, and/or the like.

In an example, the DetNet node management information container may comprise: an identifier of the DetNet node, an identifier of a network slice associated with the DetNet node, an indication that the network supports DetNet capability. The DetNet capability may comprise one or more of: the indication of DetNet relay support, the indication of DetNet transit node support, the indication of DetNet edge node support, support of protocols for DetNet configurations (e.g., NETCONF RFC6241, YANG RFC6020, PRE-CC RFC 8283, and/or the like.). In an example, the first NAS message may be the configuration update command message. In an example, the configuration update command message may be received via the AMF and the RAN node. In an example, the configuration update command message may be received from the PCF, or the TSCTSF via the SMF or the AMF. In an example, the network node may be a session management function (SMF), or an access and mobility management function (AMF). In an example, the wireless device may receive a request for a DetNet flow. The request may comprise the identifier of the DetNet flow. In an example, the request may be received from: a DetNet end station/node, a device side translator device, a DetNet network, a network side translator device, or a node of a DetNet system/DetNet network. In an example, the second NAS message may comprise an identifier of a PDU session associated with the DetNet flow. In an example, the first NAS message may comprise a DetNet flow assistance information container. In an example, the first NAS message may comprise a network slice identifier associated with the DetNet node, a data network name associated with the DetNet node, and/or the like.

In an example embodiment, a wireless device may send to a network node, a first message comprising a deterministic network (DetNet) node management information container. In an example, the network node may be control plane network node. In an example, the network node may be user plane network node (UPF).

In an example embodiment, a UE may send a registration or NAS message. The UE may receive a response indicating DetNet capability from the network.

In an example embodiment, the UE may send a report or NAS message towards DetNet controller. The report may comprise neighbor DetNet node information.

In an example embodiment, a wireless device from a first network node, a first message comprising: configuration information of a first DetNet node, an identifier of the first DetNet node, and/or the like. In an example, the wireless device may receive from a second network node, a second message comprising an identifier of a second DetNet node. In an example, the wireless device may send to a network node of the first DetNet node a third message comprising a list of adjacent DetNet nodes wherein the list of adjacent DetNet nodes comprises the identifier of the second DetNet node.

In an example embodiment, the UE may send a registration request message comprising DetNet capability. In an example, the UE receives DetNet configuration from the network (e.g., DetNet node ID).

In an example embodiment, the SMF may receive, the DetNet management container comprising: the identifier of the DetNet node. In an example, the SMF may send to a wireless device a first NAS message comprising the DetNet management container. In an example, the SMF may receive from the wireless device the second NAS message.

In an example, the DetNet node management container may comprise: a DetNet node management information container, a DetNet port management information container, and/or the like. In an example, the DetNet node management container may comprise an identifier of a DetNet flow. In an example, the DetNet node management container comprises the identifier of a session (PDU session) associated with the DetNet flow. In an example, the session may be: an N4 session, or a PDU session.

In an example, the DetNet node management information container comprises: an identifier of the DetNet node. In an example, the second NAS message may be at least one of: a PDU session establishment request message, a PDU session modification request message; and a service request message. In an example, the first NAS message may comprise the user equipment route selection policy (URSP).

In an example embodiment, the AMF may receive a first message comprising a DetNet node management container. In an example, the AMF may send to the wireless device, the configuration update command message. In an example, the first message may be received from at least one of: the PCF, the SMF, the NEF, the TSCTSF, and/or the like.

1. A method comprising:
receiving, by a wireless device from a first network node, parameters associated with a deterministic network (DetNet) node; and
sending, by the wireless device to a second network node, a first message comprising a report for the DetNet node.

2. The method of claim 1, wherein:
the first network node comprises one of:
an access and mobility management function (AMF);
a session management function (SMF); or
a user plane function (UPF); and
the second network node comprises one of:
the AMF;
the SMF; or
the UPF.

3. The method of claim 1, wherein the wireless device receives the parameters in a first non-access stratum (NAS) message.

4. The method of claim 3, wherein the first NAS message comprises a configuration for the wireless device to operate as a device side of the DetNet node.

5. The method of claim 4, wherein the parameters comprise:
an identifier of the DetNet node; and
an identifier of a network slice associated with the DetNet node.

6. The method of claim 3, wherein the first NAS message comprises at least one of:
a DetNet flow assistance information container;
an identifier of the DetNet node;
an identifier of a network slice associated with the DetNet node; or
an indication that the network supports DetNet capability wherein the DetNet capability comprises one or more of:
an indication of DetNet relay support;
an indication of DetNet transit node support;
an indication of DetNet edge node support; or
support of protocols for DetNet configurations.

7. The method of claim 3, wherein the first NAS message comprises a configuration update command message, wherein the configuration update command message is received from an access and mobility management function (AMF).

8. A wireless device comprising one or more processors and memory storing instructions that, when executed by the one or more processors, cause the wireless device to:
receive, from a first network node, parameters associated with a deterministic network (DetNet) node; and
send, to a second network node, a first message comprising a report for the DetNet node.

9. The wireless device of claim 8, wherein:
the first network node comprises one of:
an access and mobility management function (AMF);
a session management function (SMF); or
a user plane function (UPF); and
the second network node comprises one of:
the AMF;
the SMF; or
the UPF.

10. The wireless device of claim 8, wherein the wireless device receives the parameters in a first non-access stratum (NAS) message.

11. The wireless device of claim 10, wherein the first NAS message comprises a configuration for the wireless device to operate as a device side of the DetNet node.

12. The wireless device of claim 11, wherein the parameters comprise:
an identifier of the DetNet node; and
an identifier of a network slice associated with the DetNet node.

13. The wireless device of claim 10, wherein the first NAS message comprises at least one of:
a DetNet flow assistance information container;
an identifier of the DetNet node;
an identifier of a network slice associated with the DetNet node; or
an indication that the network supports DetNet capability wherein the DetNet capability comprises one or more of:
an indication of DetNet relay support;
an indication of DetNet transit node support;
an indication of DetNet edge node support; or
support of protocols for DetNet configurations.

14. The wireless device of claim 10, wherein the first NAS message comprises a configuration update command message, wherein the configuration update command message is received from an access and mobility management function (AMF).

15. A non-transitory computer-readable medium comprising instructions that, when executed by one or more processors of a wireless device, cause the wireless device to:
receive, from a first network node, parameters associated with a deterministic network (DetNet) node; and
send, to a second network node, a first message comprising a report for the DetNet node.

16. The non-transitory computer-readable medium of claim 15, wherein:
the first network node comprises one of:
an access and mobility management function (AMF);
a session management function (SMF); or
a user plane function (UPF); and
the second network node comprises one of:
the AMF;
the SMF; or
the UPF.

17. The non-transitory computer-readable medium of claim 15, wherein the wireless device receives the parameters in a first non-access stratum (NAS) message.

18. The non-transitory computer-readable medium of claim 17, wherein the first NAS message comprises a configuration for the wireless device to operate as a device side of the DetNet node.

19. The non-transitory computer-readable medium of claim 18, wherein the parameters comprise:
an identifier of the DetNet node; and
an identifier of a network slice associated with the DetNet node.

20. The non-transitory computer-readable medium of claim 17, wherein the first NAS message comprises at least one of:
a DetNet flow assistance information container,
an identifier of the DetNet node;
an identifier of a network slice associated with the DetNet node; or
an indication that the network supports DetNet capability wherein the DetNet capability comprises one or more of:
an indication of DetNet relay support;
an indication of DetNet transit node support;
an indication of DetNet edge node support; or
support of protocols for DetNet configurations.
